(19) United States
(12) Patent Application Publication
(10) Pub. No.: US 2022/0012922 A1
(43) Pub. Date: Jan. 13, 2022

(54) INFORMATION PROCESSING APPARATUS, INFORMATION PROCESSING METHOD, AND COMPUTER READABLE MEDIUM

(71) Applicant: SONY CORPORATION, TOKYO (JP)

(72) Inventor: TSUYOSHI ISHIKAWA, TOKYO (JP)

(21) Appl. No.: 17/283,472

(22) PCT Filed: Oct. 2, 2019
(86) PCT No.: PCT/JP2019/038915

§ 371 Date: Apr. 7, 2021

(30) Foreign Application Priority Data
Oct. 15, 2018 (JP) 2018-194262

(51) Int. Cl. G06T 11/00; G06T 7/20

(52) U.S. Cl. CPC G06T 11/00; G06T 7/20

(57) ABSTRACT

An information processing apparatus according to an embodiment of the present technology includes an acquisition unit, a motion detection unit, an area detection unit, and a display control unit. The acquisition unit acquires one or more captured images in which the actual space is captured. The motion detection unit detects a contact motion, which is a series of motions when a user contacts an actual object in the actual space. The area detection unit detects a target area including the actual object according to the detected contact motion. The display control unit that generates a virtual image of the actual object by extracting a partial image corresponding to the target area from the one or more captured images, and controls display of the virtual image according to the contact motion.

### TECHNICAL FIELD

The present technology relates to an information processing apparatus, an information processing method, and a computer readable medium for providing a virtual experience.

### BACKGROUND ART

Patent Literature 1 describes a system for providing a virtual experience using an image of an actual space. In this system, an image representing a field of view of a first user is generated using a wearable display worn by the first user and a wide-angle camera. This image is presented to a second user. The second user may enter a virtual object such as text and an icon into the presented image. Also, the input virtual object is presented to the first user. This makes it possible to realize a virtual experience of sharing vision among users (Patent Literature 1, paragraphs [0015]-[0017], [0051], [0062], FIGS. 1 and 3, etc.).

### CITATION LIST

### Patent Literature

Patent Literature 1: Japanese Patent Application Laid-open No. 2015-95802

### DISCLOSURE OF INVENTION

### Technical Problem

As described above, a technique for providing various virtual experiences using an image of an actual space or the like has been developed, and a technique capable of seamlessly connecting the actual space and the virtual space is demanded.

In view of the above circumstances, an object of the present technology is to provide an information processing apparatus, an information processing method, and a computer readable medium capable of seamlessly connecting the actual space and the virtual space.

### Solution to Problem

In order to achieve the above object, an information processing apparatus according to an embodiment of the present technology includes an acquisition unit, a motion detection unit, an area detection unit, and a display control unit.

The acquisition unit acquires one or more captured images in which the actual space is captured.

The motion detection unit detects a contact motion, which is a series of motions when a user contacts an actual object in the actual space.

The area detection unit detects a target area including the actual object according to the detected contact motion.

The display control unit that generates a virtual image of the actual object by extracting a partial image corresponding to the target area from the one or more captured images, and controls display of the virtual image according to the contact motion.

In this information processing apparatus, the contact motion of the user contacting the actual object is detected, and the target area including the actual object is detected according to the contact motion. The partial image corresponding to the target area is extracted from the captured image obtained by capturing the actual space in which the actual object exists, and the virtual image of the actual object is generated. Then, the display control of the virtual image is executed according to the contact motion of the user. Thus, it becomes possible to easily display the virtual image in which the actual object is captured, and to seamlessly connect the actual space and the virtual space.

The display control unit may generate the virtual image representing the actual object that is not shielded by a shielding object.

This makes it possible to bring a clear image of the actual object which is not shielded by the shielding object into the virtual space, and to seamlessly connect the actual space and the virtual space.

The display control unit may generate the partial image from the captured image in which the object is not included in the target area among the one or more captured images.

This makes it possible to easily bring the virtual image representing the actual object without shielding into the virtual space. As a result, it becomes possible to connect seamlessly the actual space and the virtual space.

The display control unit may superimpose and display the virtual image on the actual object.

Thus, the virtual image in which the actual object is duplicated is displayed on the actual object. As a result, the virtual image can be easily handled, and excellent usability can be demonstrated.

The acquisition unit may acquire the one or more captured images from at least one of a capturing apparatus that captures the actual space and a database that stores an output of the capturing apparatus.

Thus, for example, it becomes possible to easily generate the virtual image with high accuracy representing an actual object without shielding.

The contact motion may include a motion of bringing a user's hand closer to the actual object. In this case, the motion detection unit may determine whether or not a state of the contact motion is a pre-contact state in which the contact of the user's hand with respect to the actual object is predicted. In addition, if it is determined that the state of the contact motion is the pre-contact state, the acquisition unit may acquire the one or more captured images by controlling the capturing apparatus.

Thus, for example, it becomes possible to capture the actual object immediately before the user contacts the actual object. This makes it possible to sufficiently improve the accuracy of the virtual image.

The acquisition unit may increase a capturing resolution of the capturing apparatus if the state of the contact motion is determined as the pre-contact state.

This makes it possible to generate the virtual image with high resolution, for example.

The motion detection unit may detect a contact position between the actual object and the hand of the user. In this case, the area detection unit may detect the target area on the basis of the detected contact position.

Thus, for example, it becomes possible to designate a capture target, a range, and the like by a simple motion, and to seamlessly connect the actual space and the virtual space.

The area detection unit may detect a boundary of the actual object including the contact position as the target area.

Thus, for example, it becomes possible to accurately separate the actual object and the other areas, and to generate a highly precise virtual image.

The information processing apparatus may further include a line-of-sight detection unit for detecting a line-of-sight direction of the user. In this case, the area detection unit may detect the boundary of the actual object on the basis of the line-of-sight direction of the user.

Thus, it becomes possible to improve separation accuracy between the actual object to be captured and the target area. As a result, it becomes possible to generate an appropriate virtual image.

The line-of-sight detection unit may detect a gaze position on the basis of the line-of-sight direction of the user. In this case, the area detection unit may detect the boundary of the actual object including the contact position and the gaze position as the target area.

Thus, it becomes possible to greatly improve the separation accuracy between the actual object to be captured and the target area, and to sufficiently improve the reliability of the apparatus.

The area detection unit may detect the boundary of the actual object on the basis of at least one of a shadow, a size, and a shape of the actual object.

This makes it possible to accurately detect, for example, the boundary of the actual object regardless of the state of the actual object or the like. As a result, it becomes possible to sufficiently improve the usability of the apparatus.

The motion detection unit may detect a fingertip position of a hand of the user. In this case, the area detection unit may detect the target area on the basis of a trajectory of the fingertip position accompanying a movement of the fingertip position.

This makes it possible to easily set the capture range, for example.

The display control unit may superimpose and display an area image representing the target area on the actual object.

Thus, for example, it becomes possible to confirm the target area as a range of capture, and to sufficiently avoid a state such as unnecessary virtual image is generated.

The area image may be displayed such that at least one of a shape, a size, and a position can be edited. In this case, the area detection unit may change the target area on the basis of the edited area image.

Thus, it becomes possible to accurately set the capture range, and, for example, to easily generate the virtual image or the like of a desired actual object.

The motion detection unit may detect a contact position between the actual object and the hand of the user. In this case, the display control unit may control the display of the virtual image according to the detected contact position.

Thus, for example, it becomes possible to display the virtual image without a sense of discomfort according to the contact position, and to connect seamlessly the actual space and the virtual space.

The motion detection unit may detect a gesture of a hand of the user contacting the actual object. In this case, the display control unit may control the display of the virtual image according to the detected gesture of the hand of the user.

Thus, for example, it becomes possible to switch a display method of the virtual image corresponding to the gesture of the hand, and to provide an easy-to-use interface.

The virtual image may be at least one of a two-dimensional image and a three-dimensional image of the actual object.

Thus, it becomes possible to generate virtual images of various actual objects existing in the actual space, and to seamlessly connect the actual space and the virtual space.

An information processing method according to an embodiment of the present technology is an information processing method including, executed by a computer system, acquiring one or more captured images obtained by capturing an actual space.

A contact motion, which is a series of motions when a user contacts an actual object in the actual space is detected.

A target area including the actual object according to the detected contact motion is detected.

A partial image corresponding to the target area is extracted from the one or more captured images to generate a virtual image of the actual object and to control display of the virtual image according to the contact motion.

A computer readable medium with program stored thereon according to an embodiment of the present technology, the program causes a computer system to execute the following steps:

a step of acquiring one or more captured images obtained by capturing an actual space;

a step of detecting a contact motion, which is a series of motions when a user contacts an actual object in the actual space;

a step of detecting a target area including the actual object according to the detected contact motion; and

a step of generating a virtual image of the actual object by extracting a partial image corresponding to the target area from the one or more captured images, and controlling display of the virtual image according to the contact motion.

### Advantageous Effects of Invention

As described above, according to the present technology, it is possible to seamlessly connect the actual space and the virtual space. Note that the effect described here is not necessarily limitative, and any of the effects described in the present disclosure may be provided.

### BRIEF DESCRIPTION OF DRAWINGS

FIG. 1 is a schematic diagram for explaining an outline of a motion of an HMD according to an embodiment of the present technology.

FIG. 2 is a perspective view schematically showing an appearance of the HMD according to an embodiment of the present technology.

FIG. 3 is a block diagram showing a configuration example of the HMD shown in FIG. 2.

FIG. 4 is a flowchart showing an example of the motion of the HMD 100.

FIG. 5 is a schematic diagram showing an example of a contact motion with respect to the actual object of the user.

FIG. 6 is a schematic diagram showing an example of detection processing of a capture area in an area automatic detection mode.

FIG. 7 is a schematic diagram showing another example of the detection processing of the capture area in the area automatic detection mode.

FIG. 8 is a schematic diagram showing an example of correction processing of the capture area.

FIG. 9 is a schematic diagram showing an example of a captured image used for generating a virtual image.

FIG. 10 is a schematic diagram showing an example of a display of the virtual image.

FIG. 11 is a schematic diagram showing an example of a display of the virtual image.

FIG. 12 is a schematic diagram showing an example of a display of the virtual image.

FIG. 13 is a schematic diagram showing an example of a display of the virtual image.

FIG. 14 is a schematic diagram showing another example of a display of the virtual image.

FIG. 15 is a schematic diagram showing an example of the detection processing of the capture area including a shielding object.

FIG. 16 is a schematic diagram showing an example of a virtual image generated by the detection processing shown in FIG. 15.

FIG. 17 is a flowchart showing another example of the motion of the HMD.

FIG. 18 is a schematic diagram showing an example of a capture area designated by the user.

FIG. 19 is a perspective view schematically showing an appearance of the HMD according to another embodiment.

FIG. 20 is a perspective view schematically showing the appearance of a mobile terminal according to another embodiment.

### MODE(S) FOR CARRYING OUT THE INVENTION

Embodiments according to the present technology will now be described below with reference to the drawings.

[Configuration of HMD]

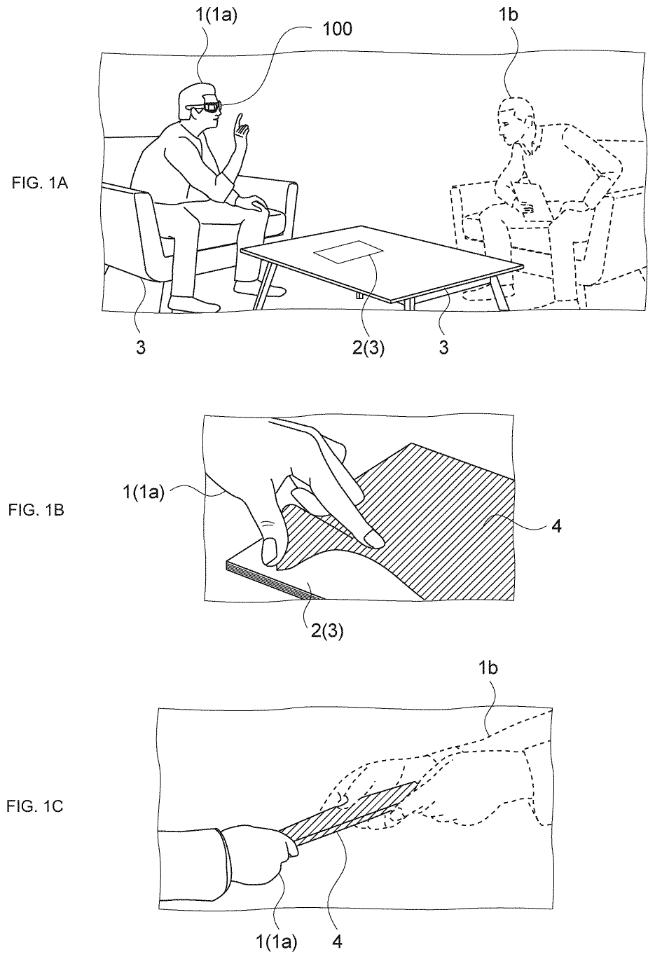

FIG. 1 is a schematic diagram for explaining an outline of a motion of an HMD according to an embodiment of the present technology. An HMD 100 (Head Mount Display) is a spectacle type apparatus having a transmission type display, and is used by being worn on a head of a user 1.

The user 1 wearing the HMD 100 will be able to visually recognize an actual scene and at the same time visually recognize an image displayed on the transmission type display. That is, by using the HMD 100, virtual images or the like can be superimposed and displayed on a real space (actual space) around the user 1. Thus, the user 1 will be able to experience an Augmented Reality (AR) or the like.

FIG. 1A is a schematic diagram showing an example virtual space (AR space) visually seen by the user 1. A user 1a wearing the HMD 100 sits on a left-side chair in FIG. 1A. An image of other user 1b sitting on the other side of a table, for example, is displayed on a display of the HMD 100. As a result, the user 1a wearing the HMD 100 can experience the augmented reality as if the user 1a were sitting face-to-face to the other user 1b.

Note that a portion indicated by solid lines in the diagram (such as chair on which user 1a sits, table, and document 2 on table) is actual objects 3 arranged in an actual space in which the user actually exists. Furthermore, a portion indicated by a dotted line in the drawing (such as other user 1b and his chair) is an image displayed on the transmission type display, and becomes a virtual image 4 in the AR space. In the present disclosure, the virtual image 4 is an image for displaying various objects (virtual objects) displayed, for example, in the virtual space.

By wearing the HMD 100 in this manner, even when the other user 1b is at a remote location, for example, conversations with gestures and the like can be naturally performed, and good communications become possible. Of course, even when the user 1a and the other user 1b are in the same space, the present technology can be applied.

The HMD 100 includes a capture function that generates the virtual image 4 of the actual object 3 in the actual space and displays it in the AR space. For example, suppose that the user 1a wearing the HMD 100 extends his hand to the document 2 on the table and contacts the document 2. In this case, in the HMD 100, the virtual image 4 of the document 2 to which the user 1a contacts is generated. In the present embodiment, the document 2 is an example of the actual object 3 in the actual space.

FIG. 1B schematically shows an example contact motion in which the user 1a contacts the document 2. For example, when the user 1a contacts the document 2, an area of the document 2 to be captured (boundary of document 2) is detected. On the basis of the detected result, the virtual image 4 (hatched area in the drawing) representing the document 2 contacted by the user 1a is generated and displayed on the HMD 100 display (AR space). A method of detecting the area to be captured, a method of generating the virtual image 4, and the like will be described in detail later.

For example, as shown in FIG. 1B, when the user 1a manually scrapes off the document 2 on the table, the captured document 2 (virtual image 4) is displayed as if it turned over the actual document 2. That is, the generated virtual image 4 is superimposed and displayed on the actual document 2 as if the actual document 2 were turned over. Note that the user 1a does not need to actually turn over the document 2, and can generate the virtual image 4 only by performing a gesture of turning over the document 2, for example.

Thus, in the HMD 100, the actual object 3 (document 2) to be captured is designated by the user 1a's hand, and a target virtual image 4 is generated. The captured virtual image 4 is superimposed and displayed on a target actual object. The virtual image 4 of the document 2 displayed in the AR space can be freely displayed in the AR space according to various gestures of the user 1a such as grabbing, deforming, or moving the virtual image 4, for example.

Furthermore, the document 2 brought into the AR space as the virtual image 4 can be freely moved in the virtual AR space. For example, FIG. 1C shows that the user 1a grabs the virtual object document 2 (virtual image 4) and hands it to the other user 1b at the remote location displayed on the HMD 100 display. By using the virtual image 4, for example, such communication becomes possible.

As described above, in the HMD 100, the actual object 3 existing in the actual space (real world) is simply captured and presented in the virtual space (virtual world). That is, it can be said that the HMD 100 has a function of simply capturing the actual space. This makes it possible to easily bring the object in the actual space into the virtual space such as the AR space, and to seamlessly connect the actual space and the virtual space. Hereinafter, the configuration of the HMD 100 will be described in detail.

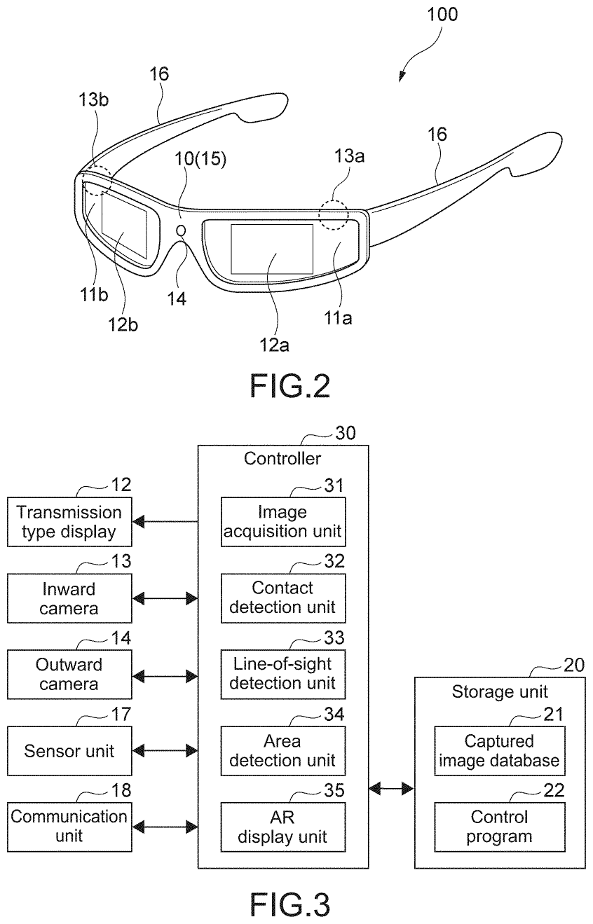

FIG. 2 is a perspective view schematically showing an appearance of the HMD 100 according to the embodiment of the present technology. FIG. 3 is a block diagram showing an example configuration of the HMD 100 shown in FIG. 2.

The HMD 100 includes a frame 10, a left-eye lens 11a and a right-eye lens 11b, a left-eye display 12a and a right-eye display 12b, a left-eye camera 13a and a right-eye camera 13b, and an outward camera 14.

The frame 10 has a shape of glasses, and includes a rim portion 15 and temple portions 16. The rim portion 15 is a portion disposed in front of the left and right eyes of the user 1, and supports each of the left eye lens 11a and the right eye lens 11b. The temple portions 16 extend rearward from both ends of the rim portion 15 toward both ears of the user 1, and tips are worn by both ears. The rim portion 15 and the temple portions 16 are formed of, for example, a material such as synthetic resin and metal.

The left-eye lens 11a and the right-eye lens 11b are respectively disposed in front of the left and right eyes of the user so as to cover at least a part of a field of view of the user. Typically, each lens is designed to correct the user's vision. Needless to say, it is not limited to this, and a so-called no-degree lens may be used.

The left-eye display 12a and the right-eye display 12b are transmission type displays, and are disposed so as to cover partial areas of the left-eye and right-eye lens 11a and 11b, respectively. That is, the left-eye and right-eye lens 11a and 11b are respectively disposed in front of the left and right eyes of the user.

Images for the left eye and the right eye and the like are displayed on the left eye and the right eye displays 12a and 12b, respectively. A virtual display object (virtual object) such as the virtual image 4 is displayed on each of the displays 12a and 12b. Therefore, the user 1 wearing the HMD 100 visually sees the actual space scene, such as the actual object 3, on which the virtual images 4 displayed on the displays 12a and 12b are superimposed.

As the left-eye and right-eye displays 12a and 12b, for example, a transmission type organic electroluminescence display, an LCD (liquid crystal display) display, or the like is used. In addition, a specific configuration of the left-eye and right-eye displays 12a and 12b is not limited, and, for example, a transmission type display of an arbitrary method such as a method of projecting and displaying an image on a transparent screen or a method of displaying an image using a prism or the like may be used, as appropriate.

The left-eye camera 13a and the right-eye camera 13b are appropriately placed in the frame 10 so that the left eye and the right eye of the user 1 can be imaged. For example, it is possible to detect a line of sight of the user 1, a gaze point that the user 1 is gazing at, and the like, on the basis of the images of the left eye and the right eye captured by the left eye and right eye cameras 13a and 13b.

As the left-eye and right-eye cameras 13a and 13b, for example, digital cameras including image sensors such as a CMOS (Complementary Metal-Oxide Semiconductor) sensor and a CCD (Charge Coupled Device) sensor are used. Furthermore, for example, an infrared camera equipped with an infrared illumination such as an infrared LED may be used.

Hereinafter, the left-eye lens 11a and the right-eye lens 11b are both referred to as lenses 11, and the left-eye display 12a and the right-eye display 12b are both referred to as transmission type displays 12 in some cases. The left-eye camera 13a and the right-eye camera 13b are referred to as inward cameras 13 in some cases.

The outward camera 14 is disposed toward outside (side opposite to user 1) in a center of the frame 10 (rim portion 15). The outward camera 14 captures an actual space around the user 1 and outputs a captured image in which the actual space is captured. A capturing range of the outward camera 14 is set to be substantially the same as the field of view of the user 1 or to be a range wider than the field of view of the user 1, for example. That is, it can be said that the outward camera 14 captures the field of view of the user 1. In the present embodiment, the outward camera 14 corresponds to a capturing apparatus.

As the outward camera 14, for example, a digital camera including an image sensor such as a CMOS sensor or a CCD sensor is used. In addition, for example, a stereo camera capable of detecting depth information of the actual space or the like, a camera equipped with a TOF (Time of Flight) sensor, or the like may be used as the outward camera 14. The specific configuration of the outward camera 14 is not limited, and any camera capable of capturing the actual space with a desired accuracy, for example, may be used as the outward camera 14.

As shown in FIG. 3, the HMD 100 further includes a sensor unit 17, a communication unit 18, a storage unit 20, and a controller 30.

The sensor unit 17 includes various sensor elements for detecting a state of a surrounding environment, a state of the HMD 100, a state of the user 1, and the like. In the present embodiment, as the sensor element, a distance sensor (Depth sensor) for measuring a distance to a target is mounted. For example, the stereo camera or the like described above is an example of a distance sensor. In addition, a LiDAR sensor, various radar sensors, or the like may be used as the distance sensor.

In addition, as the sensor elements, for example, a 3-axis acceleration sensor, a 3-axis gyro sensor, a 9-axis sensor including a 3-axis compass sensor, a GPS sensor for acquiring information of a current position of the HMD 100 or the like may be used. Furthermore, a biometric sensor (heart rate) such as an electroencephalogram sensor, an electromyographic sensor, or a pulse sensor for detecting biometric information of the user 1 may be used.

The sensor unit 17 includes a microphone for detecting sound information of a user's voice or a surrounding sound. For example, voice uttered by the user is detected, as appropriate. Thus, for example, the user can experience the AR while making a voice call and perform an operation input of the HMD 100 using a voice input. In addition, the sensor element or the like provided as the sensor unit 17 is not limited.

The communication unit 18 is a module for executing network communication, short-range wireless communication, and the like with other devices. For example, a wireless LAN module such as a Wi-Fi, and a communication module such as Bluetooth (registered trademark) are provided.

The storage unit 20 is a nonvolatile storage device, and, for example, a hard disk drive (HDD), a solid state drive (SSD), or the like is used.

The storage unit 20 stores a captured image database 21. The captured image database 21 is a database that stores, for example, an image of the actual space captured by the outward camera 14. The image or the like of the actual space captured by other camera or the like different from the outward camera 14 may be stored in the captured image database 21.

The captured image database 21 stores, for example, the captured image of the actual space and capture information relating to a capturing state of each captured image in association with each other. As the capture information, for example, when the image is captured, a capturing time, a position of the HMD 100 at the time of capturing, a capturing direction (HMD 100 attitude, etc.), a capturing resolution, a capturing magnification, an exposure time, etc. are stored. In addition, a specific configuration of the captured image database 21 is not limited. In the present embodiment, the captured image database corresponds to a database in which an output of the capturing apparatus is stored.

Furthermore, the storage unit 20 stores a control program 22 for controlling an overall motion of the HMD 100. The method of installing the captured image database 21 and the control programs 22 to the HMD 100 are not limited.

The controller 30 corresponds to the information processing apparatus according to the present embodiment, and controls motions of respective blocks of the HMD 100. The controller 30 includes a hardware configuration necessary for a computer such as a CPU and a memory (RAM, ROM). When the CPU loads and executes the control program 22 stored in the storage unit 20 to the RAM, various processes are executed.

As the controller 30, a device such as a PLD (Programmable Logic Device) such as an FPGA (Field Programmable Gate Array), other ASIC (Application Specific Integrated Circuit), or the like may be used, for example.

In the present embodiment, the CPU of the controller 30 executes the program according to the present embodiment, whereby an image acquisition unit 31, a contact detection unit 32, a line-of-sight detection unit 33, an area detection unit 34, and an AR display unit 35 are realized as functional blocks. The information processing method according to the present embodiment is executed by these functional blocks. Note that in order to realize each functional block, dedicated hardware such as an IC (integrated circuit) may be used, as appropriate.

The image acquisition unit 31 acquires one or more captured images in which the actual space is captured. For example, the image acquisition unit 31 reads the captured image captured by the outward camera 14 by appropriately controlling the outward camera 14. In this case, the image acquisition unit 31 can acquire the image captured in real time.

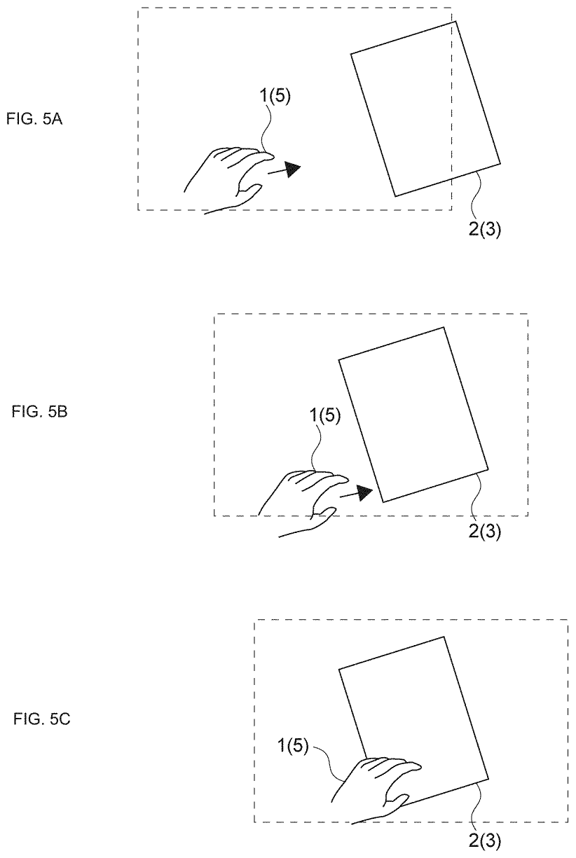

For example, when a notification that the user 1 and the actual object 3 are about to come into contact with each other is received from the contact detection unit 32, which will be described later, the image acquisition unit 31 controls the outward camera 14 to start capturing the actual object 3 to be captured. Also, in a case where the outward camera 14 is performing continuous capturing, a capturing parameter of the outward camera 14 is changed and switched to capturing a higher resolution image. That is, the image acquisition unit 31 controls the outward camera 14 so as to switch to a mode of capturing the actual object 3 to be captured. This point will be described in detail below with reference to FIG. 5 and the like.

Furthermore, for example, the image acquisition unit 31 accesses the storage unit 20 as appropriate to read a captured image 40 stored in the captured image database 21. That is, the image acquisition unit 31 can appropriately refer to the captured image database 21 and acquire the captured image captured in the past.

Thus, in the present embodiment, the image acquisition unit 31 acquires one or more captured images from at least one of the outward camera 14 for capturing the actual space and the captured image database 21 in which the output of the outward camera 14 is stored. The acquired captured image is supplied to, for example, other functional blocks, as appropriate. In addition, the captured image acquired from the outward camera 14 is appropriately stored in the captured image database 21. In this embodiment, the image acquisition unit 31 corresponds to the acquisition unit.

The contact detection unit 32 detects a series of contact motions when the user 1 contacts the actual object 3 in the actual space. As the detection of the contact motion, for example, the depth information detected by the distance sensor or the like mounted as the sensor unit 17, an image of the field of view of the user 1 captured by the outward camera 14 (captured image), or the like is used.

In the present disclosure, the contact motion is a series of motions (gestures) performed when the user 1 contacts the actual object 3, and is typically a motion performed by the user 1 so that the hand (fingers) of the user 1 contacts the actual object 3. For example, a hand gesture of the user's fingers when the hand of the user 1 contacts the actual object 3 is the contact motion. For example, hand gestures such as pinching, turning over, grabbing, tapping, and shifting the document 2 (actual object 3) are included in the contact motion. Incidentally, the hand gesture is not limited to the gesture performed while contacting the actual object 3. For example, a hand gesture or the like performed in a state where the user 1 does not contact the actual object 3, such as spreading or narrowing fingers to pinch the actual object 3, is also the contact motion.

The contact motion includes a motion of bringing the hand of the user 1 closer to the actual object 3. That is, in order to contact the actual object 3, a motion of the user 1 extending the hand to the actual object 3 to be a target is also included in the contact motion. For example, the motion (approaching motion) in which the user 1 moves the hand to approach the document 2 (actual object 3) is the contact motion. Therefore, it can be said that the contact detection unit 32 detects a series of motions performed when the user contacts the actual object 3, such as an approach motion and a hand gesture at the time of contacting as the contact motion of the user 1.

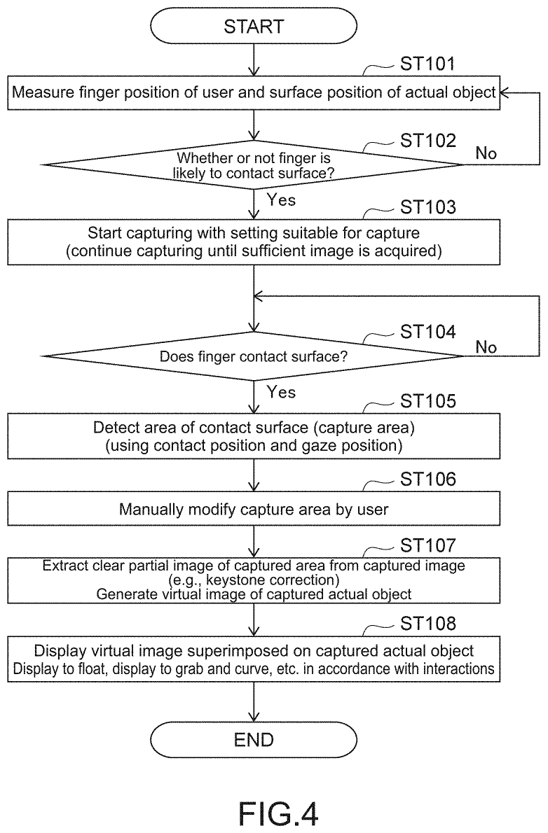

The contact detection unit 32 determines the state of the contact motion. For example, the contact detection unit determines whether or not the state of the contact motion is a pre-contact state in which the contact of the hand of the user 1 with respect to the actual object 3 is predicted. That is, it is determined whether or not the hand of the user 1 is likely to contact the actual object 3. For example, when a distance between the fingers of the user 1 and the surrounding actual object 3 is smaller than a certain threshold, it is determined that the hand of the user 1 is likely to contact the actual object 3, and the contact motion of the user 1 is in the pre-contact state (see Step 102 of FIG. 4). In this case, the state in which the distance between the fingers and the actual object 3 is smaller than the threshold and the fingers are not in contact with the actual object 3 is the pre-contact state.

In addition, the contact detection unit 32 determines whether or not the state of the contact motion is the contact state in which the hand of the user 1 and the actual object 3 are in contact with each other. That is, the contact detection unit 32 detects the contact of the fingers of the user 1 with a surface (plane) of the actual object 3.

When the contact between the user 1 and the actual object 3 is detected, the contact detection unit 32 detects a contact position P between the hand of the user 1 and the actual object 3. As the contact position P, for example, a coordinate of a position where the hand of the user 1 and the actual object 3 contact each other in a predetermined coordinate system set in the HMD 100 is detected.

A method of detecting the contact motion or the like is not limited. For example, the contact detection unit 32 appropriately measures the position of the hand of the user 1 and the position of the surrounding actual object 3 using the distance sensor or the like attached to the HMD 100. On the basis of measurement results of the respective positions, for example, it is determined whether or not the state is the pre-contact state, and it is detected whether or not the hand of the user 1 is likely to contact the actual object 3. Furthermore, for example, it is determined whether or not it is a contact state and whether or not the hand contacts the actual object 3.

In order to detect whether or not it is likely to contact, for example, prediction processing by machine learning, prediction processing using a fact that the distance between the hand of the user 1 and the actual object 3 is shortened, or the like is used. Alternatively, on the basis of a movement direction, a movement speed, and the like of the hand of the user 1, processing of predicting the contact between the user 1 and the actual object 3 may be performed.

Furthermore, the contact detection unit 32 detects the hand gesture of the user 1 on the basis of the captured image or the like captured by the outward camera 14. For example, a method of detecting the gesture by detecting an area of the fingers in the captured image, a method of detecting a fingertip of each finger and detecting the gesture, or the like may be used, as appropriate. Processing of detecting the hand gesture using machine learning or the like may be performed. In addition, a method of detecting the hand gesture or the like is not limited.

The line-of-sight detection unit 33 detects a line-of-sight direction of the user 1. For example, the line-of-sight direction of the user 1 is detected on the basis of the images of the left eye and the right eye of the user 1 captured by the inward camera 13. The line-of-sight detection unit 33 detects a gaze position Q on the basis of the line-of-sight direction of the user 1. For example, in a case where the user 1 is seeing at the certain actual object 3 in the actual space, the position where the actual object 3 and the line-of-sight direction of the user 1 intersect is detected as the gaze position Q of the user 1.

The method of detecting the line-of-sight direction and the gaze position Q of the user 1 is not limited. For example, in a configuration in which the infrared camera (inward camera 13) and an infrared light source are mounted, an image of an eyeball on which reflection (bright spot) of infrared light emitted from the infrared light source is reflected is captured. In this case, the line-of-sight direction is estimated from the bright spot of the infrared light and a pupil position, and the gaze position Q is detected.

In addition, a method of estimating the line-of-sight direction and the gaze position Q on the basis of a feature point such as a corner of the eye or the like may be used on the basis of the image of the eyeball. Furthermore, the line-of-sight direction or the gaze position Q may be detected on the basis of a change in an eye potential or the like generated by charging of the eyeball. In addition, any algorithm or the like capable of detecting the line-of-sight direction, the gaze position Q, and the like of the user 1 may be used.

The area detection unit 34 detects the capture area including the actual object 3 according to the contact motion detected by the contact detection unit 32. The capture area is, for example, an area for generating the virtual image 4 in which the actual object 3 is captured. That is, an area including the actual object 3 to be captured as the virtual image 4 can be said to be the capture area. In the present embodiment, the capture area corresponds to a target area.

For example, the captured image (hereinafter, referred to as contact image) that captures a state in which the user 1 is in contact with the actual object 3 is acquired. The area detection unit 34 analyzes the contact image and detects a range in the contact image to be captured as the virtual image 4. Note that it is not limited to the case where the capture area is detected from the contact image. For example, the capture area may be detected from the captured image other than the contact image on the basis of the contact position of the user 1 or the like.

In the present embodiment, an area automatic detection mode for automatically detecting the capture area is executed. In the area automatic detection mode, for example, the actual object 3 contacted by the user 1 is automatically identified as a capture target. Then, an area representing an extension of the surface of the actual object 3 to be captured, that is, the boundary (periphery) of the actual object 3 contacted by the user 1 may be detected as the capture area. In addition, an area representing the boundary (periphery) of the actual object 3 related to the actual object 3 contacted by the user 1 may be detected as the capture area. For example, a boundary of a document on a top surface, a back surface, or the like of a document contacted by the user 1 may be detected as the capture area. Alternatively, when one document bound with a binder or the like is contacted, the capture area may be detected, such as containing the other document.

In this manner, in the area automatic detection mode, it is detected on which surface the user 1 is about to contact and to what extent the surface is extended. This makes it possible to identify the range of the surface contacted by the user 1 (range of document 2, white board, or the like). A method of automatically detecting the capture area is not limited, and, for example, arbitrary image analysis processing capable of detecting an object, recognizing a boundary, or the like, or detection processing by the machine learning or the like may be used, as appropriate.

Furthermore, in the present embodiment, the area manual designation mode for detecting the capture area designated by the user 1 is executed. In the area manual designation mode, for example, a motion in which the user 1 traces the actual object 3 is detected as appropriate, and the range designated by the user 1 is detected as the capture area. The area automatic detection mode and the area manual designation mode will be described later in detail.

The AR display unit 35 generates an AR image (virtual image 4) displayed on a transmission type display 12 of the HMD 100 and controls the display thereof. For example, according to the state of the HMD 100, the state of the user 1, and the like, the position, the shape, the attitude, and the like of displaying the AR image are calculated.

The AR display unit 35 extracts a partial image corresponding to the capture area from one or more captured images to generate the virtual image 4 of the actual object 3. The partial image is, for example, an image generated by cutting out a portion of the captured image corresponding to the capture area. On the basis of the cut-out partial image, the virtual image 4 for displaying in the AR space is generated. Therefore, it can be said that the virtual image 4 is a partial image processed corresponding to the AR space.

For example, if the actual object 3 having a two-dimensional spread such as the document 2 and a whiteboard is captured, the virtual image 4 having a two-dimensional spread for displaying content written on the surface of the actual object 3 is generated. In this case, the virtual image 4 is a two-dimensional image of the actual object 3.

In addition, in the HMD 100, the actual object 3 having a three-dimensional shape can be captured. For example, the virtual image 4 is generated so that a stereoscopic shape of the actual object 3 can be represented in the AR space. In this case, the virtual image 4 is a three-dimensional image of the actual object 3. In this manner, the AR display unit 35 generates the virtual image 4 according to the shape of the actual object 3.

Furthermore, the AR display unit 35 generates the virtual image 4 representing the actual object 3 which is not shielded by a shielding object. Here, the state of being shielded by the shielding object (other object) is a state in which a part of the actual object 3 is hidden by the shielding object. For example, in the contact image captured in a state in which the hand of the user 1 is in contact with the actual object 3, it is conceivable that a part of the actual object 3 is hidden by the hand of the user 1. In this case, the hand of the user 1 becomes the shielding object that shields the actual object 3.

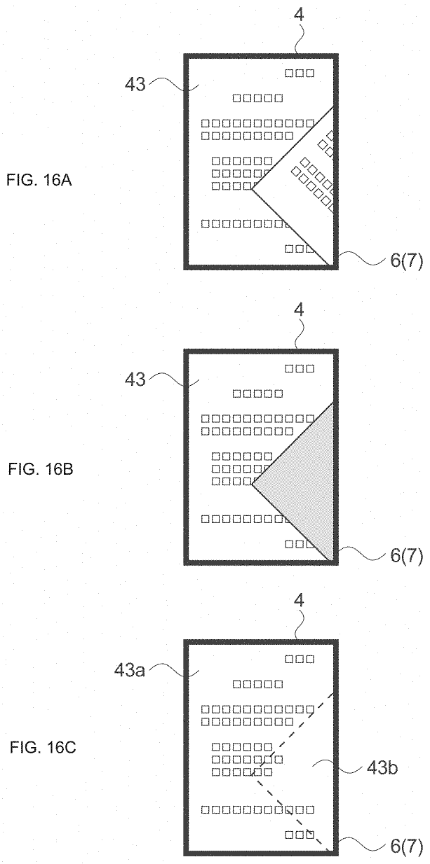

In the present embodiment, the AR display unit 35 generates the virtual image 4 in which the entire actual object 3 is displayed without shielding the actual object 3. Therefore, the virtual image 4 is a clear image representing the entire actual object 3 to be captured (see FIG. 9, etc.). As to such a virtual image 4, a partial image can be generated from the captured image, for example, in which the actual object 3 is captured without shielding. Incidentally, the virtual image 4 in which a part of the actual object 3 is shielded may be generated (see FIG. 16A, etc.).

The AR display unit 35 displays the generated virtual image 4 on the transmission type display 12 so as to overlap with the actual object 3. That is, the image (virtual image 4) of the clear actual object 3 is superimposed and displayed on the actual object 3. In addition, the virtual image 4 is displayed corresponding to the action of the hand (hand gesture) of the hand of the user 1 in contact with the actual object 3 and the like. For example, a type of the display of the virtual image 4 is changed for each type of motion that contacts the actual object 3 (such as tapping or rubbing actual object 3). In this manner, the AR display unit 35 controls the display of the virtual image 4 according to the contact motion of the user 1.

A method of generating the virtual image 4 of the actual object 3, a method of displaying the virtual image 4, and the like will be described in detail later. In the present embodiment, the AR display unit 35 corresponds to the display control unit.

[Motion of HMD]

FIG. 4 is a flowchart showing an example of a motion of the HMD 100. Processing shown in FIG. 4 is processing executed in the area automatic detection mode, and is, for example, loop processing repeatedly executed during the motion of the HMD 100.

The contact detection unit 32 measures a finger position of the user 1 and a surface position of the actual object 3 existing around the fingers of the user 1 (Step 101). Here, for example, the position of the surface of the arbitrary actual object 3 existing around the fingers is measured. Incidentally, at this timing, the actual object 3 to be contacted by the user 1 needs not be identified.

For example, on the basis of the depth information detected by the distance sensor, the position of the fingers of the user 1 and the surface position of the actual object 3 in the coordinate system set to the HMD 100 (distance sensor) is measured. In this case, it can be said that a spatial arrangement relationship between the fingers of the user 1 and the actual object 3 around the fingers is measured. As the finger position, for example, each fingertip of the user 1 directed toward the actual object 3 is detected. In addition, as the surface position, for example, a shape or the like representing the surface of the actual object 3 near the fingers of the user 1 is detected.

Furthermore, in a case where the field of view of the user 1 is captured by the outward camera 14 or the like, the finger position and the surface position (arrangement of fingers and actual object) may be appropriately detected from the depth information and the captured image. By using the outward camera 14, it is possible to improve a detection accuracy of each position. In addition, a method of detecting the finger position and the surface position is not limited.

The contact detection unit 32 determines whether or not the fingers of the user 1 are likely to contact the surface of the actual object 3 (Step 102). That is, it is determined whether or not the state of the contact motion of the user 1 is the pre-contact state in which the contact is predicted.

As the determination of the pre-contact state, for example, a threshold determination of the distance between the finger position and the surface position is performed. That is, it is determined whether or not the distance between the finger position and the surface position is larger than a predetermined threshold. The predetermined threshold is appropriately set, for example, so that capture processing of the actual object 3 can be appropriately executed.

For example, if the distance between the finger position of the user 1 and the surface position of the actual object 3 is larger than the predetermined threshold, it is determined that the fingers of the user 1 are sufficiently away from the actual object 3 and is not in the pre-contact state (No in Step 102). In this case, it returns to Step 101, the finger position and the surface position are measured at a next timing, and it is determined whether or not the state is the pre-contact state.

If the distance between the finger position and the surface position is equal to or less than the predetermined threshold, it is determined that the fingers of the user 1 are in a state of approaching the actual object 3 and is in the pre-contact state in which the contact is predicted (Yes in Step 102). In this case, the image acquisition unit 31 controls the outward camera 14, and starts capturing of the actual space with a setting suitable for capture (Step 103). That is, when an occurrence of an interaction between the actual object 3 and the user 1 is predicted, a capturing mode is switched and a detailed capture is started.

Specifically, by the image acquisition unit 31, each capturing parameter such as the capturing resolution, the exposure time, and a capturing interval of the outward camera 14 is set to a value for capturing. The value for capturing is appropriately set so that a desired virtual image 4 can be generated, for example.

For example, in a configuration in which the outward camera 14 always captures the field of view of the user 1, the capturing resolution for monitoring is set so as to suppress an amount of image data. The capturing resolution for monitoring is changed to a capturing resolution for more detailed capturing. That is, the image acquisition unit 31 increases the capturing resolution of the outward camera 14 in a case where the state of the contact motion is determined to be the pre-contact state. This makes it possible to generate a detailed captured image (virtual image 4) with high resolution, for example.

Furthermore, for example, the exposure time of the outward camera 14 is appropriately set so that the image having desired brightness and contrast is captured. Alternatively, the capturing interval is appropriately set so that a sufficient number of captured images can be captured as will be described later.

When each capturing parameter of the outward camera 14 is set to the value for capturing and the capturing mode is switched, capturing of the actual space by the outward camera 14 (capturing of field of view of user 1) is started. The captured image captured by the outward camera 14 is appropriately read by the image acquisition unit 31. Capturing processing is repeatedly executed until a predetermined condition for generating the virtual image 4 is satisfied, for example.

FIG. 5 is a schematic diagram showing an example of the contact motion of the user 1 with respect to the actual object 3. FIG. 5A schematically shows fingers 5 of the user 1 and the actual object 3 (document 2) at a timing determined to be in the pre-contact state. Note that whether or not the document 2 shown in FIG. 5A is the target of the contact motion (target to be captured) is not identified in the state shown in FIG. 5A.

In the state shown in FIG. 5A, the capturing area of the outward camera 14 (dotted line in FIG. 5A) includes the fingers 5 of the user 1 and a part of the document 2. For example, the captured image with high resolution is captured in such a capturing range. In this case, the captured image is an image in which only a part of the document 2 is captured.

FIG. 5B shows the pre-contact state in which the fingers 5 of the user 1 approach the actual object 3 closer than the state shown in FIG. 5A. In the state shown in FIG. 5B, the entire document 2 is included in the capturing area of the outward camera 14. The fingers 5 of the user 1 are not in contact with the document 2, and the document 2 is captured without being shielded by the shielding object. That is, the captured image captured in the state shown in FIG. 5B becomes an image in which the document 2 (actual object 3) that is not shielded by the shielding object is captured.

FIG. 5C shows a contact state in which the fingers 5 of the user 1 and the actual object 3 are in contact with each other. The capturing processing by the outward camera 14 may be continued even in the contact state. In this case, the entire document 2 is included in the capturing range of the outward camera 14, but a part of the document 2 is shielded by the fingers of the user 1. In this case, the captured image is an image in which a part of the document 2 is shielded.

In the capturing processing by the outward camera 14, capturing is performed in the states as shown in, for example, FIG. 5A to FIG. 5C, and the captured images in the respective states are appropriately read. Thus, in a case where the state of the contact motion is determined to be the pre-contact state, the image acquisition unit 31 controls the outward camera 14 to acquire one or more captured images. That is, it can be said that the image acquisition unit 31 acquires the image captured by a capture setting (capture image).

The period during which the capturing processing for capture by the outward camera 14 is executed is not limited. For example, the capturing processing may be continued until the virtual image 4 is generated. Alternatively, the capturing processing may be ended when a predetermined number of capturing processing is executed. Furthermore, for example, after the predetermined number of capturing processing, if there is no capturing image necessary for generating the virtual image 4, the capturing processing may be restarted. In addition, the number of times, the timing, and the like of the capturing processing may be appropriately set so that the virtual image 4 can be appropriately generated.

Returning to FIG. 4, when the capturing processing for capture is started, it is determined whether or not the fingers 5 of the user 1 contact the surface of the actual object 3 in Step 104. That is, it is determined whether or not the state of the contact motion of the user 1 is the contact state.

As the determination of the contact state, for example, a threshold determination of the distance between the finger position and the surface position is performed. For example, when the distance between the finger position and the surface position is larger than the threshold for contact detection, it is determined that the contact state is not present, and when the distance is equal to or smaller than the threshold for contact detection, it is determined that the contact state is present. A method of determining the contact state is not limited.

For example, in FIG. 5A and FIG. 5B, the fingers 5 of the user 1 and the actual object 3 (document 2) are separated from each other than the threshold for contact detection. In this case, it is determined that the fingers 5 of the user 1 are not in contact with the surface of the actual object 3 (No in Step 104), and the determination of the contact state is performed again.

Furthermore, for example, in FIG. 5C, the distance between the fingers 5 of the user 1 and the actual object 3 is equal to or less than the threshold for detecting contact. In this case, the fingers 5 of the user 1 are determined to be in contact with the surface of the actual object 3 (Yes in Step 104), and the area detection unit 34 executes the detection processing of the range (capture area) of the surface in which the fingers 5 of the user 1 are in contact (Step 105).

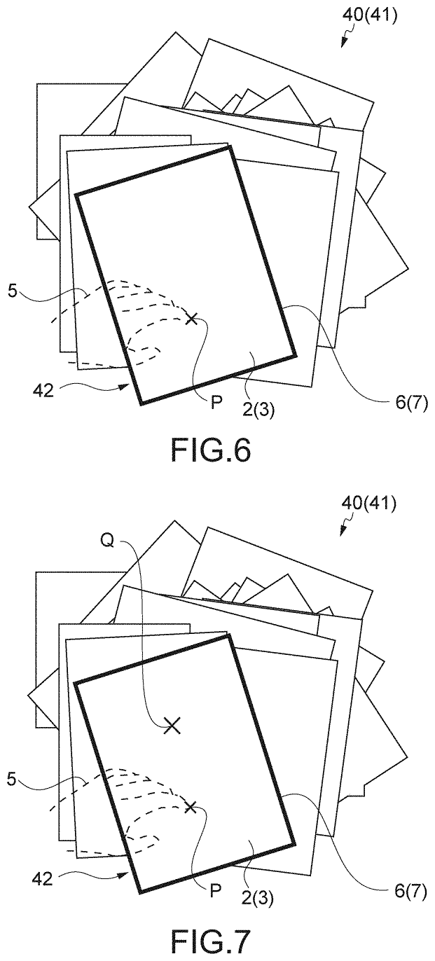

FIG. 6 is a schematic diagram showing an example of the detection processing of the capture area in the area automatic detection mode. FIG. 6 schematically shows the captured image 40 (contact image 41) captured at a timing when the fingers 5 of the user 1 are in contact with the document 2 (actual object 3). Incidentally, the fingers 5 of the user 1 are schematically shown using the dotted line.

In the example shown in FIG. 6, the fingers 5 of the user 1 are in contact with the document 2 placed at an uppermost part of the plurality of documents 2 arranged in an overlapping manner. Thus, the uppermost document 2 is the target of the contact motion of the user 1, i.e. the capture object.

In the present embodiment, when the contact is detected, the contact position P between the actual object 3 and the hand of the user 1 is detected by the contact detection unit 32. For example, in FIG. 6, the position of the fingertip of the index finger of the user 1 in contact with the uppermost document 2 is detected as the contact position P. Note that, when the user 1 contacts the actual object 3 with a plurality of fingers, the position or the like of the fingertip of each finger contacting the actual object 3 may be detected as the contact position P.

In the processing shown in FIG. 6, the capture area 6 is detected on the basis of the contact position P detected by the contact detection unit 32. Specifically, the area detection unit 34 detects a boundary 7 of the actual object 3 including the contact position P as the capture area 6. Here, the boundary 7 of the actual object 3 is, for example, an outer edge of the surface of the single actual object 3, and is a border representing the range of continuous surface of the actual object 3.

For example, in the contact image 41, the contact position P is detected on the uppermost document 2. That is, the uppermost document 2 becomes the actual object 3 including the contact position P. The area detection unit 34 performs predetermined image processing to detect the boundary 7 of the uppermost document 2. That is, a continuous surface area (capture area 6) is automatically detected by the image processing using the contact point (contact position P) of the surface contacted by the fingers 5 of the user 1 as a hint. In the example shown in FIG. 6, the rectangular capture area 6 corresponding to the boundary 7 of the uppermost document 2 is detected.

For example, a region where a color changes discontinuously in the contact image 41 is detected as the boundary 7. Alternatively, the boundary 7 may be detected by detecting successive lines (such as straight lines or curves) in the contact image 41. When the target to be captured is the document 2 or the like, the boundary 7 may be detected by detecting the arrangement or the like of characters on a document surface.

In addition, for example, in the case of a thick document 2, a turning document 2, or the like, a shadow may be generated at the outer edge thereof. The boundary 7 of the actual object 3 may be detected on the basis of the shadow of the actual object 3. As a result, it is possible to properly detect the capture area 6 of the actual object 3 having a color same as a color of a background.

Furthermore, the boundary 7 of the actual object 3 may be detected on the basis of the size of the actual object 3 to be captured. The size of the actual object 3 is, for example, a size in the actual space, and is appropriately estimated on the basis of the size of the user 1's hand, the depth information, and the like. For example, a range of the size held by the user 1 is appropriately set, and the boundary 7 of the actual object 3 or the like is detected so as to fall within the range. Thus, for example, when the hand contacts the document 2 (actual object 3) placed on the table, not the table but the boundary 7 of the document 2 is detected. As a result, unnecessarily large or small size boundary or the like are prevented from being detected, and it makes possible to property detect the capture area 6.

Furthermore, for example, with respect to the actual object 3 having a fixed shape such as the document 2 or the like, the boundary 7 of the actual object 3 may be detected on the basis of the shape. The shape of the actual object 3 is, for example, a shape in the actual space. For example, it is possible to estimate the shape viewed from a front by performing correction processing such as a keystone correction on the contact image 41 captured obliquely. For example, the boundary 7 of the document 2 having an A4 shape, a postcard shape, or the like is detected on the basis of information about a shape such as an aspect ratio. Incidentally, the information about the size and the shape of the actual object 3 may be acquired, for example, via an external network or the like, or may be acquired on the basis of the past captured image 40 stored in the captured image database 21 or the like. In addition, any method capable of detecting the boundary 7 of the actual object 3 may be used.

FIG. 7 is a schematic diagram showing another example of the detection processing of the capture area in the area automatic detection mode. In the processing shown in FIG. 7, the capture area 6 is detected on the basis of the contact position P and the gaze position Q of the user 1. That is, the line of sight of the user 1 is used to detect the spread of the surface on which the fingers 5 of the user 1 are about to contact.

For example, the line-of-sight detection unit 33 detects the gaze position Q of the user 1 in the contact image 41 on the basis of the line-of-sight direction of the user 1 detected at the timing when the contact image 41 is captured. For example, as shown in FIG. 7, since it is highly likely that the user 1 is simultaneously viewing the selected actual object 3 (uppermost document 2) by the line of sight, the gaze position Q of the user 1 is highly likely to be detected on the actual object 3.

In the processing shown in FIG. 7, the boundary 7 of the actual object 3 including the contact position P and the gaze position Q is detected as the capture area 6 by the area detection unit 34. That is, the boundary 7 of the continuous surface where the contact position P and the gaze position Q are present is detected. As a method of detecting the boundary 7, for example, various methods described with reference to FIG. 6 are used. This makes it possible to greatly improve the detection accuracy of the capture area 6 (boundary 7 of target actual object 3).

Note that it is not limited to the case where the gaze position Q is used. For example, processing may be performed in which a gaze area of the user is calculated on the basis of the line-of-sight direction of the user 1, and the boundary 7 of the actual object 3 including the contact position P and the gaze area is detected in the contact image 41. In addition, the boundary 7 of the actual object 3 may be detected using an arbitrary method using the line-of-sight direction of the user 1 or the like.

In this manner, the area detection unit 34 detects the boundary 7 of the actual object 3 on the basis of the line-of-sight direction of the user 1. Thus, it becomes possible to highly precisely determine the target that the user 1 attempts to contact, and to properly detect the boundary 7. As a result, it becomes possible to accurately capture the actual object 3 desired by the user 1, and to improve reliability of the apparatus.

Note that in a case where the user 1 is seeing at a place other than a contact target, etc., the contact position P and the gaze position Q may not be detected on the same actual object 3. In such a case, the boundary 7 of the actual object 3 including the contact position P is detected as the capture area 6. Thus, it is possible to sufficiently avoid a state in which an erroneous area is detected.

The information about the capture area 6 (boundary 7 of actual object 3) detected by the processing shown in FIG. 6, FIG. 7, or the like is output to the AR display unit 35.

In the present embodiment, the AR display unit 35 superimposes and displays each area image 42 representing the capture area 6 on the actual object 3. For example, in the examples shown in FIG. 6 and FIG. 7, each area image 42 representing the boundary 7 of the uppermost document 2 is generated and displayed on the transmission type display 12 so as to overlap with the boundary 7 of the uppermost document 2. As a result, the user 1 will be able to visually see the area on the actual space to be captured.

The specific configuration of the area image 42 is not limited. For example, the capture area 6 may be represented by a line displayed in a predetermined color or the like. Alternatively, a line or the like representing the capture area 6 may be displayed by an animation such as blink or the like. In addition, the entire capture area 6 may be displayed using a predetermined pattern or the like having transparency.

Note that even when a viewpoint of the user 1 (HMD 100) changes, for example, the area image 42 is displayed by appropriately adjusting the shape, a display position, and the like so as to be superimposed on the actual object 3. Thus, the capture area 6 visible by the AR display (rectangular area frame, etc.) is corrected by a manual operation as described below.

Returning to FIG. 4, when the capture area 6 is detected, an input operation of the user 1 for modifying the capture area 6 is accepted (Step 106). That is, in Step 106, the user 1 will be able to manually modify the capture area 6.

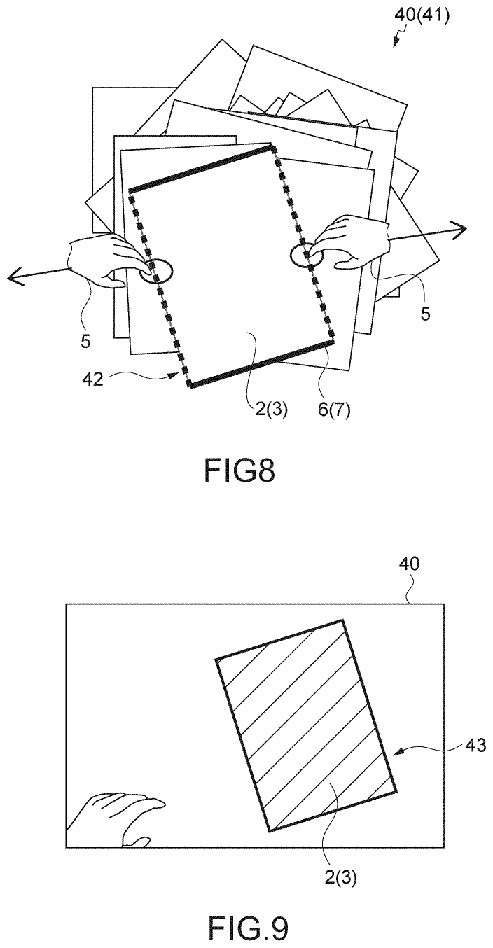

FIG. 8 is a schematic diagram showing an example of the correction processing of the capture area 6. FIG. 8 shows an image similar to the contact image 41 described with reference to FIG. 6 and FIG. 7. In the boundary 7 of the uppermost document 2 (actual object 3), the area image 42 for correction is schematically shown.

In the present embodiment, the area image 42 is displayed such that at least one of the shape, the size, and the position can be edited. In the HMD 100, for example, by detecting the position or the like of the fingers 5 of the user 1, the input operation by the user 1 on a display screen (transmission type display 12) is detected. The area image 42 is displayed so as to be editable according to the input operation (correction operation) of the user 1.

In the example shown in FIG. 8, a fingertip of the left hand of the user 1 is arranged at a position overlapping with a left side of the capture area 6. Furthermore, a fingertip of the right hand of the user 1 is arranged at a position overlapping with a right side of the capture area 6. In this case, the AR display unit 35 receives the operation input from the user 1 for selecting the left and right sides of the capture area 6. Incidentally, in FIG. 8, the left and right sides selected are shown using a dotted line. In this manner, the display of the capture area 6 may be appropriately changed so as to indicate that each part is selected.

For example, if the user 1 moves the left hand to the left and the right hand to the right, the left side of the capture area 6 is dragged to the left and the right side is dragged to the right. As a result, the visible capture area 6 is enlarged in the left-right direction by the user 1 by spreading by hand, and the size and shape are modified. Of course, it is also possible to enlarge the capture area 6 in the up-down direction.

In addition, the position of the capture area 6 may also be modifiable. For example, if the user 1 arranges the fingers 5 inside the capture area 6 and moves the fingers 5, the correction operation may be accepted, such as moving the capture area 6 corresponding to the movement direction of the fingers or the movement amount of the fingers. In addition, the area image 42 is displayed so as to be able to accept any correction operation corresponding to the hand operation of the user 1.

In this way, the range of the actual object 3 to be captured is automatically determined by the detection processing of the capture area 6, but this range can be further manually corrected. This makes it possible to easily perform fine adjustment or the like of the capture area 6, and to generate the virtual image 4 or the like in which the range desired by the user 1 is properly captured. After the modification operation by the user 1 is completed, the capture area 6 is changed on the basis of the edited area image 42.

Note that the capturing processing of the captured image 40 for capture described in Step 103 may be continued while the modification (editing) of the capture area 6 is being executed. In this case, processing of changing the setting of the outward camera 14 for capture to a capturing parameter optimal for capturing the edited capture area 6 is executed.

For example, if the outward camera 14 has an optical zoom function or the like, an optical zoom ratio or the like of the outward camera 14 is appropriately adjusted corresponding to the captured area 6 after editing. Thus, for example, even when the size of the capture area 6 is small, it is possible to generate the virtual image 4 with high resolution or the like. Of course, other capturing parameters may be changed.

Incidentally, the processing of manually correcting the capture area 6 may not be executed. In this case, it is possible to shorten the time to display the virtual image 4. Also, a mode for modifying the capture area 6 may be selectable.

Returning to FIG. 4, the virtual image 4 is generated on the basis of the captured image 40 captured by the outward camera 14 (Step 107). Specifically, a clear partial image of the capture area 6 is extracted from the captured image 40 (capture video) captured in Step 103. Then, using the partial image, the virtual image 4 of the captured actual object 3 is generated.

In the present embodiment, the AR display unit 35 generates the partial image from the captured image 40 that does not include the shielding object in the captured area 6 among the one or more captured images 40 captured by the outward camera 14. That is, the partial image corresponding to the capture area 6 is generated by using a frame of the captured image that is not shielded by the shielding object (finger of user 1).

For example, the actual object 3 to be captured is detected from each captured image 40 captured after the pre-contact state is detected. The actual object 3 to be captured is appropriately detected by matching processing using, for example, feature point matching or the like. A method of detecting the capture target from each captured image 40 is not limited.

It is determined whether or not the actual object 3 to be captured included in each captured image 40 is shielded. That is, it is determined whether or not the capture area 6 in each captured image 40 includes the shielding object. For example, if the boundary 7 of the actual object 3 to be captured is discontinuously cut, it is determined that the actual object 3 is shielded. Furthermore, for example, if each finger 5 of the user 1 is detected in each captured image 40 and each finger 5 is included in the capture area 6, it is determined that the actual object 3 is shielded. A method of determining presence or absence of shielding is not limited.

Of the respective captured images 40, the captured image 40 in which the actual object 3 to be captured is determined not to be shielded is selected. Thus, the captured image 40 in which the actual object 3 to be captured is not shielded, that is, the captured image 40 in which the actual object 3 to be captured is captured in a clear manner is used as the image for generating the virtual image 4.

FIG. 9 is a schematic diagram showing an example of the captured image 40 used for generating the virtual image 4. The captured image 40 shown in FIG. 9 is a schematic diagram showing the captured image 40 captured in the pre-contact state shown in FIG. 5B.

In the captured image 40 shown in FIG. 9, the entire document 2, which is the actual object 3 to be captured, is captured. The document 2 includes the clear image of the document 2 that is not hidden by the fingers 5 of the user 1 and is not shielded by the shielding object. The AR display unit 35 generates a partial image 43 corresponding to the capture area 6 from such a captured image 40. In FIG. 9, the partial image 43 (document 2) to be generated is represented by a hatched area.

Note that the captured images 40 may include an image in which a part of the capture area 6 (actual object 3) is cut off (see FIG. 5A), an image in which a part of the capture area 6 (actual object 3) is shielded (see FIG. 5C), and the like. For example, the partial image 43 may be generated by complementing clear portions of the capture area 6 among these images. For example, such processing is also possible.

When the partial image 43 is generated, correction processing such as the keystone correction is executed. For example, if the captured image 40 is captured from an oblique direction, even a rectangular document may be captured by being deformed into a keystone shape. Such deformation is corrected by keystone correction processing, and the rectangular partial image 43 is generated, for example. In addition, noise removal processing for removing a noise component of the partial image 43, processing for correcting a color, brightness, or the like of the partial image 43, or the like may be appropriately performed.

On the basis of the partial image 43, the virtual image 4 for displaying the partial image 43 (actual object 3 to be captured) in the AR space is generated. That is, the virtual image 4 for displaying the planar partial image 43 in a three-dimensional AR space is appropriately generated.

Thus, in the present embodiment, when the contact between the actual object 3 and each finger 5 of the user 1 is predicted, the capturing mode of the outward camera 14 is switched and the detailed captured image 40 is continuously captured. Then, when the actual object 3 (capture target) brought into the virtual world is designated by the contact of each finger 5, the captured image is traced back, and a clear virtual image 4 of the actual object 3 is generated using the image (captured image 40) in which each finger 5 of the user 1 does not overlap. Thus, the user 1 will be able to easily create a high-quality copy (virtual image 4) of the actual object 3 with a simple operation.

The AR display unit 35 displays the virtual image 4 superimposed on the actual object 3 (Step 108). That is, the user 1 will be able to visually see the virtual image 4 displayed by superimposing on the actual object 3 captured in reality. By displaying the captured image (virtual image 4) of the actual object 3 on the actual object 3, for example, the user 1 can intuitively understand that the actual object 3 is copied into the AR space.

The virtual image 4 of the actual object 3 copied from the actual space can be handled freely in the AR space. Thus, it makes possible, for example, the user 1 to perform a motion such as grabbing the copied virtual image 4 and passing it to a remote partner (see FIG. 1). As described above, by using the present technology, information in the actual space will be able to easily bring into the virtual space.

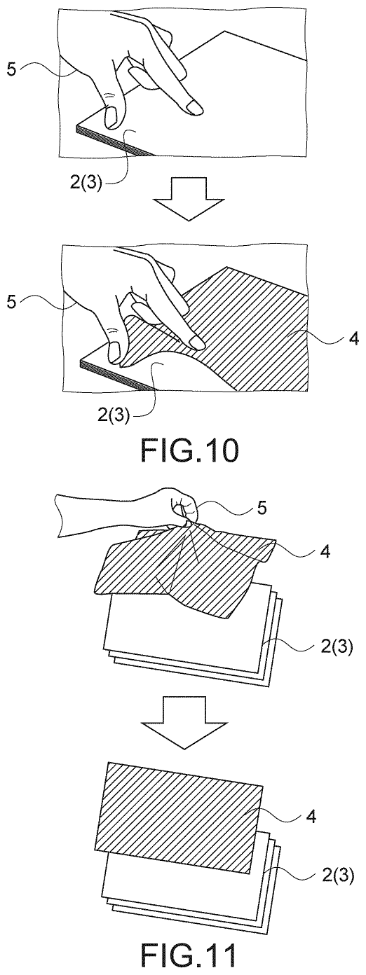

FIGS. 10 to 13 are schematic diagrams each showing an example of the display of the virtual image 4. In the present embodiment, the gesture of the hand of the user 1 contacting the actual object 3 is detected by the contact detection unit 32. The AR display unit 35 controls the display of the virtual image 4 corresponding to the gesture of the hand of the user 1 detected by the contact detection unit 32.

That is, the virtual image 4 is superimposed on the actual object 3 corresponding to the designated operation when the user 1 designates the capture target. Hereinafter, with reference to FIGS. 10 to 13, variations of a superimposed display of the captured image (virtual image 4) corresponding to the gesture (hand gesture) of the hand of the user 1 will be described.

In the example shown in FIG. 10, the hand gesture in which the user 1 turns over the document 2 (actual object 3) is performed. For example, as shown in the upper drawing of FIG. 10, it is assumed that the user 1 contacts a corner of the document 2 with the thumb and the index finger open. In this case, as shown in the lower diagram of FIG. 10, the display of the virtual image 4 is controlled so as to display the corner of the document 2 turned over between the thumb and the index finger of the user 1. A display example shown in FIG. 10 is the same as the display example shown in FIG. 1B.

The virtual image 4 is superimposed and displayed on the actual document 2 in reality in a state in which a periphery of the contact position P is turned over, for example. Thus, the virtual image 4 is displayed in the same manner as actual paper, and an visual effect is exhibited. As a result, even in the AR space, it is possible to provide a natural virtual experience in which the actual document 2 is turned over.

Also, for example, the virtual image 4 may be displayed only in the vicinity of the position where each finger of the user 1 contacts (corner of document 2). In this case, when the user 1 performs the motion of grabbing the virtual image 4, processing such as displaying the entire virtual image 4 is performed.

In this manner, the display of the virtual image 4 may be controlled according to the contact position P detected by the contact detection unit 32. Thus, immediately after the user 1 comes into contact with the actual object 3 (document 2), the virtual image 4 is displayed only in the vicinity of the contact position P, so that it is possible to suppress a processing amount of the image processing and the like. This makes possible to smoothly display the virtual image 4 without a sense of discomfort. In addition, unnecessary processing is avoided, so that power consumed by the HMD 100 can be suppressed.

In the example shown in FIG. 11, the hand gesture is performed in which the user 1 pinches and pulls up a center portion of the document 2 (actual object 3). For example, as shown in the upper drawing of FIG. 11, when the user 1 performs the operation of pinching the document 2 with the thumb and the index finger, the document 2 of the virtual image 4 (virtual paper) is superimposed and displayed on the actual document 2 in a pinched shape.

As shown in the lower drawing of FIG. 11, when the user 1 moves the hand away from the virtual image 4, the virtual image 4 remains at that position. At this time, the virtual image 4 is displayed so as to return from the pinched shape to a planar shape and stay in a floating state above the actual document 2. In this case, for example, the user 1 can grab and move the virtual image 4 displayed floating in the air. Incidentally, after the user 1 releases the hand, the virtual image 4 may be gradually lowered to a position just above the actual document 2.

In addition, in the hand gesture of pinching, when the actual object 3 such as the document 2 is brought into the AR space, the captured actual object 3 present in the actual space may be grayed out. That is, the processing of filling the actual object 3 as a copy source with gray may be performed. By graying out the actual object 3 in this manner, it becomes possible to easily present that a clone of the actual object 3 is generated in the AR space.

Incidentally, the object after the capture, i.e. the copied virtual image 4 may be marked so as to be known as the virtual object on the AR. Thus, it becomes possible to easily distinguish between the virtual image 4 and the actual object 3. The graying-out processing, the AR mark addition processing, and the like may be appropriately applied to the case where other hand gesture is executed.

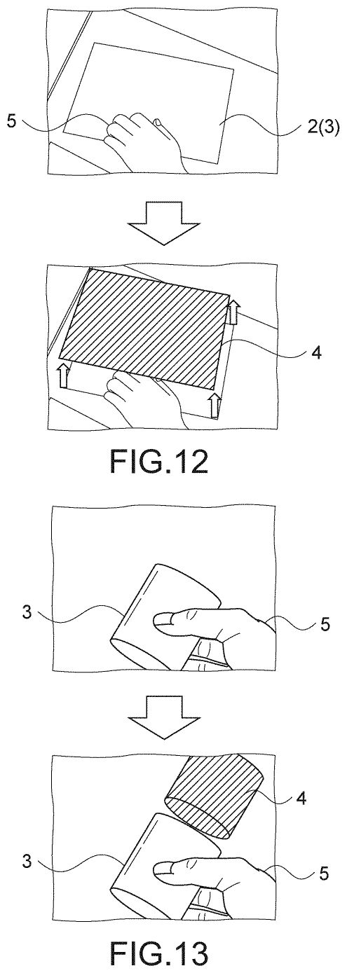

In the example shown in FIG. 12, the hand gesture is performed in which the user 1 taps the document 2 (actual object 3). For example, as shown in the upper drawing of FIG. 12, suppose that the user 1 taps the surface of the actual document 2 with the fingertips. In this case, as shown in the lower drawing of FIG. 12, the virtual image 4 is superimposed and displayed on the actual document 2 as if it were floating. At this time, an effect may be added such that the two-dimensional virtual image 4 is curved and floats like actual paper.

Furthermore, processing may be performed such that the virtual image 4 is gradually raised and displayed from a position tapped by the user 1. Furthermore, for example, when the hand gesture is performed in which the user 1 momentarily rubs the actual document 2, processing may be performed in which the virtual image 4 is raised in the rubbed direction.

In the example shown in FIG. 13, the hand gesture in which the user 1 grips the cylindrical actual object 3 is executed. It is also possible to capture such a stereoscopic actual object 3. For example, as shown in the upper drawing of FIG. 13, it is assumed that the user 1 grabs or grips the actual object 3. For example, a state in which a force is applied to the actual object 3 is detected from the arrangement of the fingers 5 of the user 1 or the like. In this case, as shown in the lower diagram of FIG. 13, the virtual image 4 in which the cylindrical actual object 3 is copied is generated as appropriate, and the virtual image 4 is gradually displayed in the vicinity of the actual object 3 so as to be squeezed out.

In this case, the virtual image 4 is a three-dimensional image representing the stereoscopic actual object 3. For example, the three-dimensional image is generated by 3D capture that captures three-dimensionally the three-dimensional actual object 3 (stereoscopic object). In the 3D capture, for example, other camera other than the outward camera 14 is also used in conjunction to capture the actual object 3. Then, on the basis of the captured image 40 captured by the respective cameras, the depth information or the like detected by the distance sensor, 3D modelling of the actual object 3 is executed. Incidentally, even when capturing the planar actual object 3, other camera may be used in conjunction therewith.

When the captured image (virtual image 4 representing 3D model) is presented, it may take longer to display in order to perform modelling or the like. In such a case, a coarse virtual image 4 (3D model) may be initially presented and be replaced with progressively highly precise data. This allows to display the virtual image 4 at high speed, even when the stereoscopic actual object 3 or the like is captured.

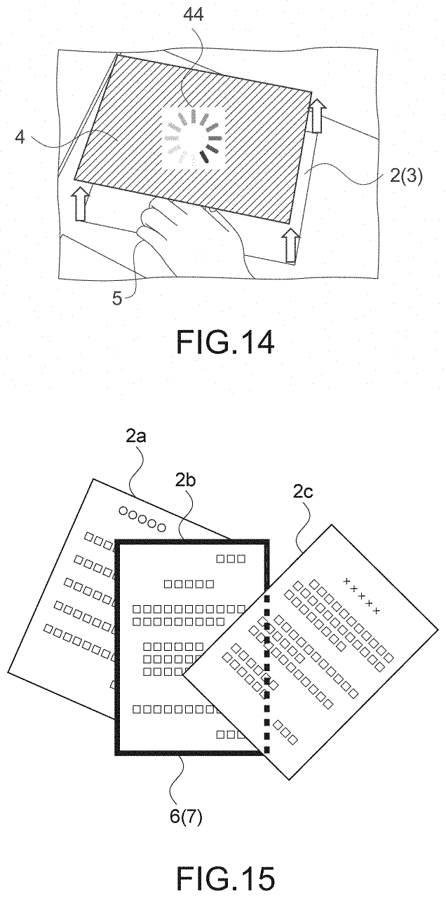

FIG. 14 is a schematic diagram showing other example of the display of the virtual image. In the example illustrated in FIG. 14, the virtual image 4 is displayed corresponding to the hand gesture in which the user 1 taps the document 2 (actual object 3). In the example shown in FIG. 14, the virtual image 4 in which an icon 44 indicating that processing is in progress is displayed is generated in a frame in which the shape of the document 2 (shape of capture area 6) is copied.

For example, when the virtual image 4 of the actual object 3 is generated, processing such as a noise removal and the keystone correction of the partial image 43 is performed as described above. Performing the processing may require some time for the actual object 3 to generate the captured virtual image 4. Thus, the icon 44 or the like indicating that processing is in progress is displayed instead of the captured image until the final virtual image 4 is generated.

Incidentally, when the final virtual image 4 is generated, the display is switched from the icon 44 indicating that processing is in progress to the final virtual image 4 in which the actual object 3 is copied. A type of the icon 44, a method of switching the display, and the like are not limited. For example, processing of fading-in may be performed such that the final virtual image 4 gradually becomes darker.

In the above description, as an example of the actual object 3, the capture processing of the document 2 which is disposed at the uppermost part and is not shielded. For example, the present technology is also applicable to the actual object 3 shielded by other actual objects 3 or the like.

FIG. 15 is a schematic diagram showing an example of the detection processing of the capture area 6 including the shielding object. FIG. 16 is a schematic diagram showing an example of the virtual image 4 generated by the detection processing shown in FIG. 15.

FIG. 15 schematically shows first to third document 2a to 2c arranged being partially overlapped. The first document 2a is the backmost document and is partially shielded by the second document 2b. The second document 2a is arranged between the first and third documents 2a and 2c and is partially shielded by the third document 2c. The third document 2c is the topmost document and is not shielded.

For example, suppose that the fingers 5 of the user 1 contact the surface of the second document 2b. In this case, the area detection unit 34 detects the boundary 7 of the second document 2b. As shown in FIG. 15, a part of the boundary 7 of the second document 2b (dotted line in the drawing) is shielded by the third document 2c. The shielded boundary 7 is detected on the basis of, for example, the unshielded boundary 7 (thick solid lines in the drawing) or the like by complementing as appropriate.

Thus, the area to be cut out (capture area 6) is determined by automatically detecting the capture area 6, but the actual object 3 (second document 2b) to be cut out may be partially hidden. In this case, in the captured image 40 captured by the outward camera 14, it is conceivable that other shielding object is on top of the intended actual object 3 and a part cannot be captured.

In the AR display unit 35, the virtual image 4 of the actual object 3 (second document 2b) shielded by the shielding object is generated, for example, by the methods shown in FIG. 16A to FIG. 16C.

In the example shown in FIG. 16A, the virtual image 4 representing the state of being shielded by the shielding object is generated as it is. For example, the captured image 40 including the capture area 6 is appropriately selected from the captured image 40 captured by the outward camera 14. Then, the partial image 43 corresponding to the capture area 6 is generated from the selected captured image 40, and the virtual image 4 using the partial image 43 is generated.

Therefore, the virtual image 4 shown in FIG. 16A is an image representing a condition in which a part of the second document 2b is shielded by the third document 2c. Thus, by using the partial image 43 as it is, it becomes possible to shorten the processing of generating the virtual image 4 and to improve a response speed to the interaction of the user 1.

In the example shown in FIG. 16B, the virtual image 4 in which a part shielded by the shielding object is grayed out is generated. For example, the boundary 7 of the actual object 3 is detected from the partial image 43 generated in the same manner as in FIG. 16A. That is, the boundary 7 of the shielding object (third document 2c) included in the partial image 43 is detected. Then, the virtual image 4 in which the inside of the boundary 7 of the shielding object is filled with a gray scale is generated. By filling out unnecessary information in this way, it becomes possible to explicitly present a missing part.

In the example shown in FIG. 16C, the virtual image 4 is generated in which the part shielded by the shielding object is complemented by other data. For example, on the basis of the description of a front face of the second document 2b, the captured image database 21 is referred, and the captured image 40 or the like in which the document 2 similar to the second document 2b is captured is searched. Predetermined matching processing or the like is used to search for the similar documents 2.

In a case where the captured image 40 including the similar document 2 is searched, the partial image 43b of the missing part shielded by the third document 2c is generated from the captured image 40. Then, the virtual image 4 of the second document 2b is generated using a partial image 43a of the non-shielded area and a partial image 43b of the missing part. Therefore, the virtual image 4 is an image in which the two partial images 43a and 43b are combined.

In this manner, by inquiring of the captured image database 21 or the like, the missing part is complemented from the similar document of the target document 2. Thus, even when the actual object 3 shielded by the shielding object becomes the capture target, it becomes possible to generate the virtual image 4 representing the actual object 3 not shielded. Note that since there is a possibility that the searched similar document is different from the target document 2, the complemented area is explicitly displayed by using a frame line (dotted line in the drawing) or the like. Thus, it becomes possible to notify that the virtual image 4 is complemented and generated.

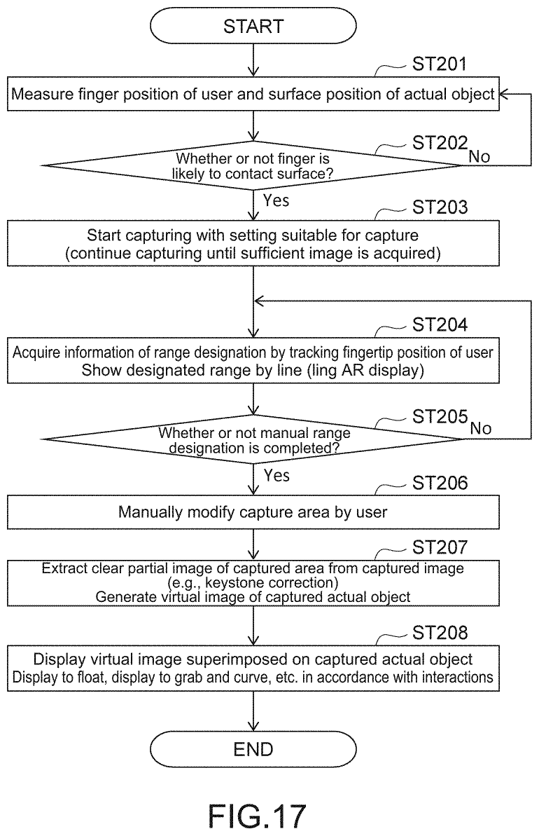

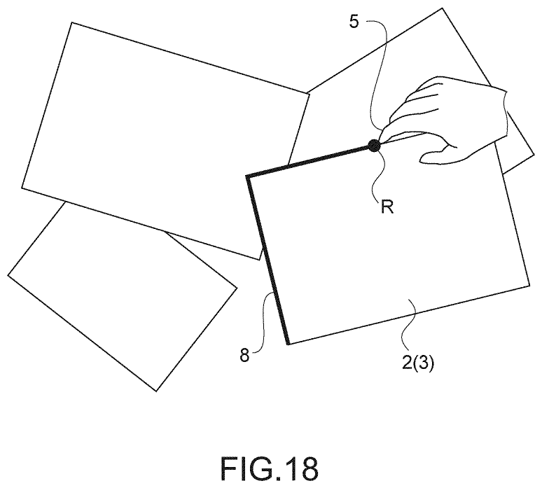

FIG. 17 is a flowchart showing other example motion of the HMD 100. The processing shown in FIG. 17 is processing executed in the area manual designation mode, and is, for example, loop processing repeatedly executed during the motion of the HMD 100. The following describes the processing when the user 1 manually designates the capture area 6 (area manual designation mode).

In Steps 201 to 203 shown in FIG. 17, for example, the same processing as in Steps 101 to 103 in the area automatic detection mode shown in FIG. 4 is executed. In Steps 206 to 208, the same processing as in Steps 206 to 208 shown in FIG. 4, for example, is performed using the capture area 6 manually designated by the user 1.

The finger position of the user 1 and the surface position of the actual object 3 are measured (Step 201), and it is determined whether or not the fingers 5 of the user 1 are likely to come into contact with the surface of the actual object 3 (Step 202). If it is determined that the fingers 5 of the user 1 are not likely to contact the surface (it is not pre-contact state in which contact is predicted) (No in Step 202), Step 201 is executed again.

If it is determined that the fingers 5 of the user 1 are likely to come into contact with the surface (it is pre-contact state in which contact is predicted) (Yes in Step 202), the capturing processing is started using the outward camera 14 in a setting suitable for the capture (Step 203). This capturing processing is repeatedly executed until, for example, the virtual image 4 is generated.

When the capturing processing is started, the detection processing of the capture area 6 designated by the user 1 is executed (Step 204). More specifically, a fingertip position R of the user 1 is tracked, and the information of a range designation is acquired. The designated range is displayed on the AR space, as appropriate.

FIG. 18 is a schematic diagram showing an example of the capture area 6 designated by the user 1. FIG. 18 schematically shows a state in which the user 1 moves the index finger 5 so as to trace the outer circumference of the document 2, which is the actual object 3.

When the area manual designation mode is executed, the fingertip position R of the hand of the user 1 is detected by the contact detection unit 32. As the fingertip position R, for example, a tip position of the finger 5 of the user 1 at a position closest to the actual object 3 is detected. Note that the fingers 5 of the user 1 may be in contact with or away from the surface of the actual object 3. That is, regardless of whether the state of the contact motion of the user 1 is the contact state or the pre-contact state, the fingertip position R of the user 1 is appropriately detected.

The information of the fingertip position R of the user 1 is sequentially recorded as range designation information by the user 1. As shown in FIG. 17, Step 204 is the loop processing, and, for example, every time Step 204 is executed, the information of the fingertip position R of the user 1 is recorded. That is, it can be said that the tracking processing of the fingertip position R for recording a trajectory 8 of the fingertip position R of the user 1 is executed.

FIG. 18 schematically shows the fingertip position R of the user 1 using a black circle. In addition, the trajectory 8 of the fingertip position R detected by tracking the fingertip position R is schematically shown using a thick black line. The information of the trajectory 8 of the fingertip position R is the range designation information by the user 1.

In addition, the AR display unit 35 displays the frame line or the like at the position tracked by the user 1 with the fingertip by the AR. That is, the trajectory 8 of the fingertip position R of the user 1 is displayed on the AR space. Therefore, for example, as shown in FIG. 18, the user 1 becomes possible to visually see a state in which a trace of own fingertip (finger 5) is displayed on the actual object 3 in a superimposed manner. As a result, it becomes possible to easily execute the designation of the capture area 6 and the usability is improved.

Returning to FIG. 17, it is determined whether or not a manual range designation by the user 1 is completed (Step 205). For example, it is determined whether or not the range input by the user 1 (trajectory 8 of fingertip position R) is a closed range. Alternatively, it is determined whether or not the fingertip (finger 5) of the user 1 is separated from the surface of the actual object 3. In addition, a method of determining the completion of the range designation is not limited. For example, the operation of designating the range may be terminated on the basis of the hand gesture or other input operation of the user 1.

If it is determined that the manual range designation is not completed (No in Step 205), Step 204 is executed, and tracking of the fingertip position R or the like is continued.

If it is determined that the manual range designation is completed (Yes in Step 205), the area detection unit 34 detects the range designated by the user 1 as the capture area 6. That is, it can be also said that the trajectory 8 of the fingertip position R of the user 1 is set in the capture area 6.

Thus, in the area manual designation mode, the area detection unit 34 detects the capture area 6 on the basis of the trajectory 8 of the fingertip position R being associated with the movement of the fingertip position R. Thus, it becomes possible to manually designate the capture area 6 and to capture an arbitrary area in the actual space. As a result, for example, it becomes possible to easily provide the virtual experience with a high degree of freedom, for example.

When the range designation is completed and the capture area 6 is detected, processing of accepting a manual correction of the capture area 6 is executed (Step 206). When the capture area 6 is corrected, the partial image 43 in which the capture area 6 is clearly captured is appropriately extracted from the captured image 40, and the virtual image 4 of the actual object 3 is generated on the basis of the partial image 43 (Step 207). The generated virtual image 4 is superimposed on the actual object 3 and appropriately displayed corresponding to the hand gesture or the like of the user 1.

Note that a method or the like of generating and displaying the virtual image 4 on the basis of the manually designated capture area 6 is not limited, and the method described with reference to FIG. 10 to FIG. 16, for example, is applicable. That is, it is possible to appropriately replace the description about the automatically detected capture area 6 described above with the description about the manually designated capture area 6.

Note that each mode of the area automatic detection mode and the area manual designation mode may be individually executed, or may be appropriately switched and executed. For example, if the hand gesture of the user 1 is the gesture for designating the area, the area manual designation mode is executed, and if it is another gesture such as tapping the actual object 3, the area automatic detection mode is executed. For example, such a configuration may be employed.

As described above, in the controller 30 according to the present embodiment, the contact motion, which is a series of operations when the user contacts the actual object 3, is detected, and the capture area 6 including the actual object 3 is detected according to the contact motion. The partial image 43 corresponding to the capture area 6 is extracted from the captured image 40 captured from the actual space in which the actual object 3 exists, and the virtual image 4 of the actual object 3 is generated. Then, the display control of the virtual image 4 is executed according to the contact motion of the user 1. This makes possible to easily display the virtual image 4 in which the actual object 3 is captured and to seamlessly connect the actual space and the virtual space.

As a method of capturing the real world, for example, a method of automatically capturing the real world in response to a predetermined input operation is conceivable. This method requires, for example, the motion that designates the range to be captured, and the capture processing may be cumbersome. In addition, since the capturing is automatically executed corresponding to the timing at which the input operation is performed, for example, there may be a case where the shielding object or the like is included in the capturing range. In this case, it is necessary to re-capture the image or the like, which may interfere with the user's experience, etc.

In the present embodiment, the capture area 6 is detected according to the contact motion of the user 1 with respect to the actual object 3. Thus, for example, when the user 1 contacts the actual object 3, the capture area 6 for capturing the actual object 3 is automatically detected.

That is, even when the user 1 does not explicitly set the capture area 6 or the like, it is possible to easily generate the virtual image 4 or the like in which the desired actual object 3 is captured. As a result, the user 1 can easily bring an appropriate captured image (virtual image 4) into the virtual space without inputting the capture area 6. As a result, it becomes possible to connect seamlessly the actual space and the virtual space.

Also, in the present embodiment, the partial image corresponding to the capture area 6 is extracted from one or more captured images 40 in which the actual space is captured, and the virtual image 4 is generated. Thus, for example, it becomes possible to acquire the partial image in which no shielding is generated backward in time, and to generate the clear virtual image 4 or the like of the actual object 3 in which no shielding is generated. As a result, it becomes possible to appropriately generate the desired virtual image 4 by the capture processing at one time, and to sufficiently avoid an occurrence of re-capturing or the like.

In addition, the generated virtual image 4 is superimposed and displayed on the actual object 3 according to the contact motion of the user 1. Thus, in the HMD 100, when the contact motion (interaction) occurs, the highly precise virtual image 4 generated on the basis of the image captured immediately before is presented. The display of the virtual image 4 is appropriately controlled corresponding to the type of the contact motion or the like. This makes it possible to naturally bring the actual object 3 of the real world into the AR space or the like. As a result, the movement of the object from the real world (actual space) to the virtual world (virtual space) becomes easy, and it becomes possible to realize a seamless connection between the real world and the virtual world.

### OTHER EMBODIMENTS

The present technology is not limited to the embodiments described above, and can achieve various other embodiments.

In the processing described with reference to FIG. 4 and FIG. 17, after the pre-contact state in which the contact between the user 1 and the actual object 3 is predicted is detected, the capturing processing is started by the outward camera 14 with the setting for capturing (Step 103 and Step 203). The timing at which the capturing processing is executed is not limited.

For example, the capturing processing may be performed in a state in which the pre-contact state is not detected. For example, the capturing processing may be performed in which the object having a possibility of contact around the user 1 is sequentially captured to prepare for the contact.

In addition, in a case where the actual object 3 that the user 1 is trying to contact cannot be designated, the actual object 3 that the user 1 is likely to contact may be captured in a speculative manner. For example, the user 1 wearing the HMD 100 directs the line of sight in various directions, it is possible to capture the various actual objects 3 around the user 1. For example, when the actual object 3 existing around the user 1 is included in the capturing range of the outward camera 14, the capturing processing for capture is executed in a speculative manner.

This makes possible to configure a library or the like in which the actual object 3 around the user 1 is captured in the captured image database 21. As a result, even in a state where, for example, it is difficult to capture the target of the contact motion of the user 1 immediately before, it becomes possible to appropriately generate the virtual image 4 of the actual object 3 contacted by the user 1. Alternatively, the capturing processing may be executed at any timing before the virtual image 4 is generated.

When the capture fails, for example, captured object data or the like on a cloud to which the HMD 100 is connectable via the communication unit 18 or the like may be searched. This makes it possible to generate the virtual image 4 even when the appropriate captured image 40 is not included in the captured image database 21 or the like.

In FIG. 13, the user 1 grabs the stereoscopic actual object 3 to generate the three-dimensional image (virtual image 4) representing the three-dimensional shape of the actual object 3. For example, a capturing method may be switched to any of 2D capture and 3D capture corresponding to the type of gesture. For example, when the user 1 performs the gesture for pinching the actual object 3, the 2D capture is performed, and when the user 1 performs the gesture for grabbing the actual object 3, the 3D capture is performed. For example, such processing may be executed.

In the above embodiment, the transmission type HMD 100 on which the transmission type display is mounted is used. For example, the present technology is applicable to a case where an immersive HMD covering the field of view of the user 1 is used.

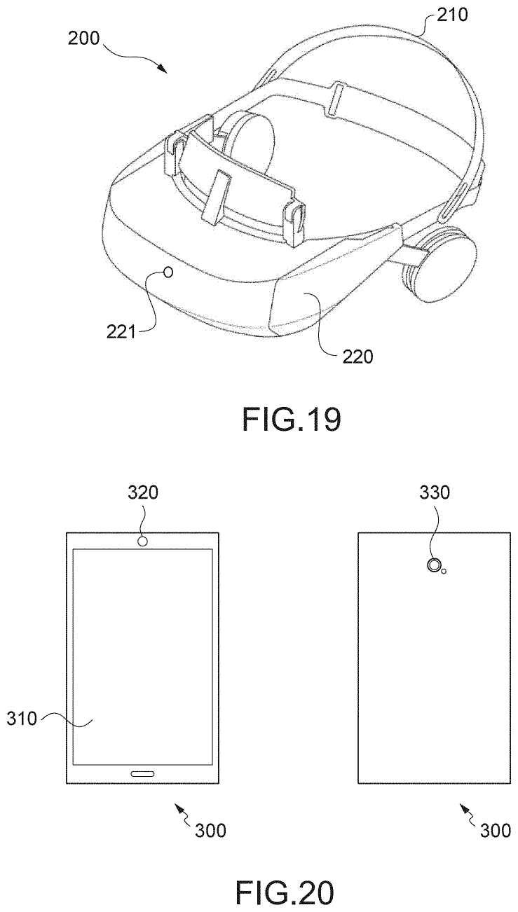

FIG. 19 is a perspective view schematically showing an appearance of the HMD according to another embodiment. An HMD 200 includes a mounting portion 210 worn on the head of the user 1 and a body portion 220 positioned in front of both eyes of the user 1. The HMD 200 is an immersive head mounted display configured to cover the field of view of the user 1.

The body portion 220 includes a display (not shown) arranged to face the left and right eyes of the user 1. An image for the left eye and an image for the right eye are displayed on this display, which allows the user 1 to visually see the virtual space.

Also, on the outside of the main portion 220, an outward camera 221 is mounted. By displaying an image captured by the outward camera 221 on an internal display, the user 1 can visually recognize a video of the real world. In the display, various virtual images 4 are superimposed and displayed on the image captured by the outward camera. As a result, it is possible to provide the virtual experience using the augmented reality (AR).

For example, the controller 30 and the like described with reference to FIG. 3 are used to perform the contact motion of the user 1 with respect to the actual object 3, the detection of the capture area 6, the display control of the virtual image 4 and the like on the display, and the like. Thus, it becomes possible to easily generate the virtual image 4 in which the actual object 3 that the user 1 contacts is captured and to display the virtual image 4 in the virtual space, whereby the actual space and the virtual space can be seamlessly connected.

FIG. 20 is a perspective view schematically showing an appearance of a mobile terminal 300 according to another embodiment. On the left and right sides of FIG. 20, a front side of the mobile terminal 300 in which a display surface 310 is provided, and a back side opposite to the front side are respectively schematically shown. On the front side of the mobile terminal 300, an inward camera 320 is mounted. On the back side, an outward camera 330 is mounted.

For example, on the display surface 310 of the mobile terminal 300, the image of the actual space captured by the outward camera 330 is displayed. In addition, on the display surface 310, various virtual images 4 and the like are superimposed and displayed with respect the image in the actual space. This allows the user 1 to visually see the AR space in which the actual space is expanded.

For example, using the controller 20 or the like described with reference to FIG. 3, it is possible to capture the actual object 3 according to the contact motion of the user 1 from the image captured by the outward camera 330. This makes it possible to easily bring the actual object 3 into the AR space. As described above, the present technology is also applicable to the case where the mobile terminal 300 or the like is used. Alternatively, a tablet terminal, a notebook PC, or the like may be used.

Furthermore, the present technology is also applicable in the virtual reality (VR) space. For example, in the actual space in which the user 1 who visually sees the VR space actually acts, the actual object 3 contacted by the user 1 is captured. This makes it possible to easily bring the object in the actual space into the VR space. As a result, it becomes possible to exchange a clone (virtual image 4) of the actual object 3 between users who are experiencing the VR space, thereby activating communication.

In the above description, the case where the information processing method according to the present technology is executed by the controller mounted on the HMD or the like is described. However, the information processing method and the program according to the present technology may be executed by other computer capable of communicating with the controller mounted on the HMD or the like via a network or the like. In addition, the controller mounted on an HMD or the like and other computer may be interlocked to construct a virtual space display system according to the present technology.

In other words, the information processing method and the program according to the present technology may be executed not only in a computer system configured by a single computer but also in a computer system in which a plurality of computers operates in conjunction with each other. Note that, in the present disclosure, a system refers to a set of components (apparatus, module (parts), and the like) and it does not matter whether or not all of the components are in a same housing. Therefore, a plurality of apparatuses housed in separate housing and connected to one another via a network, and a single apparatus having a plurality of modules housed in single housing are both the system.

Execution of the information processing method and the program according to the present technology by a computer system include, for example, both cases where detection of the contact motion of the user, detection of the target area including the actual object, generation of the virtual image, display control of the virtual image, or the like, is executed by a single computer, and where each process is executed by a different computer. Furthermore, the execution of each process by a predetermined computer includes causing other computer to execute some or all of those processes and acquiring results thereof.

That is, the information processing method and the program according to the present technology can be applied to a configuration of cloud computing in which one function is shared and processed together among multiple apparatuses via a network.

In the present disclosure, “same”, “equal”, “perpendicular”, and the like are concepts including “substantially same”, “substantially equal”, “substantially perpendicular”, and the like. For example, the states included in a predetermined range (e.g., within range of ±10%) with reference to “completely same”, “completely equal”, “completely perpendicular”, and the like are also included.

At least two of the features of the present technology described above can also be combined. In other words, various features described in the respective embodiments may be combined discretionarily regardless of the embodiments. Furthermore, the various effects described above are not limitative but are merely illustrative, and other effects may be provided.

The present technology may also have the following structures.

(1) An information processing apparatus, including:

an acquisition unit that acquires one or more captured images obtained by capturing an actual space;

a motion detection unit that detects a contact motion, which is a series of motions when a user contacts an actual object in the actual space;

an area detection unit that detects a target area including the actual object according to the detected contact motion; and

a display control unit that generates a virtual image of the actual object by extracting a partial image corresponding to the target area from the one or more captured images, and controls display of the virtual image according to the contact motion.

(2) The information processing apparatus according to (1), in which

the display control unit generates the virtual image representing the actual object not shielded by a shielding object.

(3) The information processing apparatus according to (2), in which

the display control unit generates the partial image from the captured image that does not include the shielding object in the target area among the one or more captured images.

(4) The information processing apparatus according to any one of (1) to (3), in which

the display control unit superimposes and displays the virtual image on the actual object.

[5] The information processing apparatus according to any one of (1) to (4), in which

the acquisition unit acquires the one or more captured images from at least one of a capturing apparatus that captures the actual space and a database that stores an output of the capturing apparatus.

(6) The information processing apparatus according to (5), in which

the contact motion includes a motion of bringing a hand of the user closer to the actual object,

the motion detection unit determines whether or not a state of the contact motion is a pre-contact state in which a contact of the hand of the user with respect to the actual object is predicted, and

the acquisition unit acquires the one or more captured images by controlling the capturing apparatus if the state of the contact motion is determined as the pre-contact state.

(7) The information processing apparatus according to (6), in which

the acquisition unit increases a capturing resolution of the capturing apparatus if the state of the contact motion is determined as the pre-contact state.

(8) The information processing apparatus according to any one of (1) to (7), in which

the motion detection unit detects a contact position between the actual object and the hand of the user, and

the area detection unit detects the target area on a basis of the detected contact position.

(9) The information processing apparatus according to (8), in which

the area detection unit detects a boundary of the actual object including the contact position as the target area.

(10) The information processing apparatus according to (9), further including:

a line-of-sight detection unit that detects a line-of-sight direction of the user, wherein

the area detection unit detects the boundary of the actual object on a basis of the line-of-sight direction of the user.

(11) The information processing apparatus according to (10), in which

the line-of-sight detection unit detects a gaze position on a basis of the line-of-sight direction of the user, and

the area detection unit detects the boundary of the actual object including the contact position and the gaze position as the target area.

(12) The information processing apparatus according to any one of (1) to (11), in which

the area detection unit detects the boundary of the actual object on a basis of at least one of a shadow, a size, and a shape of the actual object.

(13) The information processing apparatus according to any one of (1) to (12), in which

the motion detection unit detects a fingertip position of the hand of the user, and

the area detection unit detects the target area on a basis of a trajectory of the fingertip position accompanying a movement of the fingertip position.

(14) The information processing apparatus according to any one of (1) to (13), in which

the display control unit superimposes and displays an area image representing the target area on the actual object.

(15) The information processing apparatus according to (14), in which

the area image is displayed such that at least one of a shape, a size, and a position can be edited, and

the area detection unit changes the target area on a basis of the edited area image.

(16) The information processing apparatus according to any one of (1) to (15), in which

the motion detection unit detects a contact position between the actual object and the hand of the user, and

the display control unit controls the display of the virtual image according to the detected contact position.

(17) The information processing apparatus according to any one of (1) to (16), in which

the motion detection unit detects a gesture of the hand of the user contacting the actual object, and

the display control unit controls a display of the virtual image according to the detected gesture of the hand of the user.

(18) The information processing apparatus according to any one of (1) to (17), in which

the virtual image is at least one of a two-dimensional image and a three-dimensional image of the actual object.

(19) An information processing method including, executed by a computer system:

acquiring one or more captured images obtained by capturing an actual space;

detecting a contact motion, which is a series of motions when a user contacts an actual object in the actual space;

detecting a target area including the actual object according to the detected contact motion; and

generating a virtual image of the actual object by extracting a partial image corresponding to the target area from the one or more captured images, and controlling display of the virtual image according to the contact motion.

(20) A computer readable medium with program stored thereon, the program causes a computer system to execute:

a step of acquiring one or more captured images obtained by capturing an actual space;

a step of detecting a contact motion, which is a series of motions when a user contacts an actual object in the actual space;

a step of detecting a target area including the actual object according to the detected contact motion; and

a step of generating a virtual image of the actual object by extracting a partial image corresponding to the target area from the one or more captured images, and controlling display of the virtual image according to the contact motion.

### REFERENCE SIGNS LIST

1 user
3 actual object
4 virtual image
5 finger
6 capture area
7 boundary
8 trajectory
12 transmission type display
14 outward camera
21 captured image database
30 controller
31 image acquisition unit
32 contact detection unit
33 line-of-sight detection unit
34 area detection unit
35 AR display unit
40 captured image
42 area image
43, 43a, 43b partial image
100, 200 HMD

1. An information processing apparatus, comprising:
an acquisition unit that acquires one or more captured images obtained by capturing an actual space;
a motion detection unit that detects a contact motion, which is a series of motions when a user contacts an actual object in the actual space;
an area detection unit that detects a target area including the actual object according to the detected contact motion; and
a display control unit that generates a virtual image of the actual object by extracting a partial image corresponding to the target area from the one or more captured images, and controls display of the virtual image according to the contact motion.

2. The information processing apparatus according to claim 1, wherein
the display control unit generates the virtual image representing the actual object not shielded by a shielding object.

3. The information processing apparatus according to claim 2, wherein
the display control unit generates the partial image from the captured image that does not include the shielding object in the target area among the one or more captured images.

4. The information processing apparatus according to claim 1, wherein
the display control unit superimposes and displays the virtual image on the actual object.

5. The information processing apparatus according to claim 1, wherein
the acquisition unit acquires the one or more captured images from at least one of a capturing apparatus that captures the actual space and a database that stores an output of the capturing apparatus.

6. The information processing apparatus according to claim 5, wherein
the contact motion includes a motion of bringing a hand of the user closer to the actual object,
the motion detection unit determines whether or not a state of the contact motion is a pre-contact state in which a contact of the hand of the user with respect to the actual object is predicted, and
the acquisition unit acquires the one or more captured images by controlling the capturing apparatus if the state of the contact motion is determined as the pre-contact state.

7. The information processing apparatus according to claim 6, wherein
the acquisition unit increases a capturing resolution of the capturing apparatus if the state of the contact motion is determined as the pre-contact state.

8. The information processing apparatus according to claim 1, wherein
the motion detection unit detects a contact position between the actual object and the hand of the user, and
the area detection unit detects the target area on a basis of the detected contact position.

9. The information processing apparatus according to claim 8, wherein
the area detection unit detects a boundary of the actual object including the contact position as the target area.

10. The information processing apparatus according to claim 9, further comprising:
a line-of-sight detection unit that detects a line-of-sight direction of the user, wherein
the area detection unit detects the boundary of the actual object on a basis of the line-of-sight direction of the user.

11. The information processing apparatus according to claim 10, wherein
the line-of-sight detection unit detects a gaze position on a basis of the line-of-sight direction of the user, and
the area detection unit detects the boundary of the actual object including the contact position and the gaze position as the target area.

12. The information processing apparatus according to claim 9, wherein
the area detection unit detects the boundary of the actual object on a basis of at least one of a shadow, a size, and a shape of the actual object.

13. The information processing apparatus according to claim 1, wherein
the motion detection unit detects a fingertip position of the hand of the user, and
the area detection unit detects the target area on a basis of a trajectory of the fingertip position accompanying a movement of the fingertip position.

14. The information processing apparatus according to claim 1, wherein
the display control unit superimposes and displays an area image representing the target area on the actual object.

15. The information processing apparatus according to claim 14, wherein
the area image is displayed such that at least one of a shape, a size, and a position can be edited, and
the area detection unit changes the target area on a basis of the edited area image.

16. The information processing apparatus according to claim 1, wherein
the motion detection unit detects a contact position between the actual object and the hand of the user, and
the display control unit controls the display of the virtual image according to the detected contact position.

17. The information processing apparatus according to claim 1, wherein
the motion detection unit detects a gesture of the hand of the user contacting the actual object, and
the display control unit controls a display of the virtual image according to the detected gesture of the hand of the user.

18. The information processing apparatus according to claim 1, wherein
the virtual image is at least one of a two-dimensional image and a three-dimensional image of the actual object.

19. An information processing method comprising, executed by a computer system:
acquiring one or more captured images obtained by capturing an actual space;
detecting a contact motion, which is a series of motions when a user contacts an actual object in the actual space;
detecting a target area including the actual object according to the detected contact motion; and
generating a virtual image of the actual object by extracting a partial image corresponding to the target area from the one or more captured images, and controlling display of the virtual image according to the contact motion.

20. A computer readable medium with program stored thereon, the program causes a computer system to execute:
a step of acquiring one or more captured images obtained by capturing an actual space;
a step of detecting a contact motion, which is a series of motions when a user contacts an actual object in the actual space;
a step of detecting a target area including the actual object according to the detected contact motion; and
a step of generating a virtual image of the actual object by extracting a partial image corresponding to the target area from the one or more captured images, and controlling display of the virtual image according to the contact motion.
